(19) United States
(12) Patent Application Publication
(10) Pub. No.: US 2024/0329556 A1
(43) Pub. Date: Oct. 3, 2024

(54) TRANSFER DEVICE AND IMAGE FORMING APPARATUS

(71) Applicant: FUJIFILM Business Innovation Corp., Tokyo (JP)

(72) Inventors: Satoya SUGIURA, Kanagawa (JP); Hiroaki TANAKA, Kanagawa (JP); Masato ONO, Kanagawa (JP); Yosuke KUBO, Kanagawa (JP); lori NISHIMURA, Kanagawa (JP); Shigeru FUKUDA, Kanagawa (JP); Daisuke TANEMURA, Kanagawa (JP); Masayuki SEKO, Kanagawa (JP); Koichi MATSUMOTO, Kanagawa (JP)

(73) Assignee: FUJIFILM Business Innovation Corp., Tokyo (JP)

(21) Appl. No.: 18/451,495

(22) Filed: Aug. 17, 2023

(30) Foreign Application Priority Data
Mar. 28, 2023 (JP) 2023-052431

(51) Int. Cl. G03G 15/01; G03G 9/08; G03G 15/02; G03G 15/16

(52) U.S. Cl. CPC G03G 15/0131; G03G 9/08; G03G 15/0189; G03G 15/0216; G03G 15/162

(57) ABSTRACT

A transfer device includes an intermediate transfer member consisting of an endless belt which consists of a layer containing a resin including at least one resin selected from the group consisting of a polyimide resin, a polyamide-imide resin, an aromatic polyether ether ketone resin, a polyphenylene sulfide resin, and a polyetherimide resin, conductive carbon particles, a silicone oil containing at least one polymer selected from the group consisting of dimethylpolysiloxane and organic group-substituted dimethylpolysiloxane or has the layer as an outermost layer, and in which an integral value of a statistical quantity L(r) represented by the following Equation (1) is 0 or more and 0.1 or less at an interparticle distance r of 0.05 μm or more and 0.30 μm or less in a spatial distribution of the conductive carbon particles existing in a 6.3 μm×4.2 μm evaluation region within an outer peripheral surface of the endless belt, a primary transfer device having a primary transfer roll made of a metal that applies an electric field to the intermediate transfer member by coming into contact with an inner peripheral surface of the intermediate transfer member, and performing primary transfer of a toner image formed on a surface of an image holder to the outer peripheral surface of the intermediate transfer member, and a secondary transfer device performing secondary transfer of the toner image transferred to the outer peripheral surface of the intermediate transfer member to a surface of a recording medium.

$$L ( r ) := \sqrt{K ( r ) / π} - r \qquad ( 1 )$$

[In Equation (1), r represents the interparticle distance, and K(r) represents the Ripley's K function K(r) represented by the following Equation (2).]

$$K ( r ) := \frac{{\sum }_{i \neq j}^{N} 1 ( \vert {X}_{i} - {X}_{j} \vert \leq r ) / s ( \vert {X}_{i} - {X}_{j} \vert )}{{λ}^{2}} \qquad ( 2 )$$

[In Equation (2), 1(|Xᵢ−Xⱼ|≤r) represents an indicator function, Xᵢ and Xⱼ represent coordinates of points i and j respectively, |Xᵢ−Xⱼ| represents a Euclidean distance between the coordinates Xᵢ and Xⱼ, r represents the interparticle distance, s(|Xᵢ−Xⱼ|) represents an edge correction factor s(x) of an evaluation region represented by the following Equation (3), x equals |Xᵢ−Xⱼ|, N represents the total number of particles in the evaluation region, and λ represents a number density of particles in the evaluation region.]

$$s ( x ) := {L}_{x} {L}_{y} - \frac{x}{π} ( 2 {L}_{x} + 2 {L}_{y} - x ) \qquad ( 3 )$$

[In Equation (3), Lₓ and L_{y} represent lengths (μm) of the sides of the evaluation region in an x-axis direction and a y-axis direction respectively, x equals |Xᵢ−Xⱼ|, Xᵢ and Xⱼ represent coordinates of points i and j respectively, and |Xᵢ−Xⱼ| represents a Euclidean distance between the coordinates Xᵢ and Xⱼ.]

### CROSS-REFERENCE TO RELATED APPLICATIONS

This application is based on and claims priority under 35 USC 119 from Japanese Patent Application No. 2023-052431 filed Mar. 28, 2023.

### BACKGROUND

### (i) Technical Field

The present invention relates to a transfer device and an image forming apparatus.

### (ii) Related Art

In an image forming apparatus (such as a copy machine, a facsimile machine, or a printer) using an electrophotographic method, a toner image formed on the surface of an image holder is transferred to the surface of a recording medium and fixed on the recording medium such that an image is formed. For the transfer of the toner image to the recording medium, for example, a transfer device including a conductive endless belt such as an intermediate transfer belt is used.

For example, JP1999-202648A discloses an image forming apparatus including an image carrier, a developing device, an intermediate transfer member, and a secondary transfer device, the intermediate transfer member is configured with a plurality of layers including a substrate and a surface layer, the substrate is configured with a resin material in which a conducting agent is dispersed, the surface layer is configured with a resin material in which a conducting agent and a hydrophobic inorganic material having an average particle size of 1 μm or less are dispersed, and a volume resistivity of the surface layer is 10^{9.5} Ωcm to 10¹³ Ωcm.

JP2006-243031A discloses an image forming apparatus including an image carrier, an intermediate transfer belt, and a secondary transfer roll, in which the secondary transfer roll and the intermediate transfer belt are arranged in pressure contact with each other, and an outer peripheral surface of the intermediate transfer belt is in contact with the secondary transfer roll in a state of conforming to the external shape of the secondary transfer roll.

### SUMMARY

In recent years, due to the demand for low cost, it has been required to use a primary transfer roll made of a metal that applies an electric field to an endless belt in a state of coming into contact with the inner peripheral surface of the endless belt, as a primary transfer member that performs primary transfer of a toner image formed on the surface of an image holder to an intermediate transfer member consisting of the endless belt.

However, in a transfer device having an intermediate transfer member consisting of an endless belt, a primary transfer device having a primary transfer roll made of a metal, and a secondary transfer device, the primary transfer roll made of a metal is rigid and has high conductivity. Therefore, the charge is likely to be conducted along the outer peripheral surface of the endless belt in the axial direction of the primary transfer roll, the electric field between the endless belt and the image holder is applied obliquely, and a toner is scattered due to the deviation of a toner image from a transfer position. As a result, a phenomenon where an image appears as an afterimage in a region in which the image is not supposed to be formed (hereinafter, also called “ghost phenomenon”) is likely to occur.

Aspects of non-limiting embodiments of the present disclosure relate to a transfer device that has an intermediate transfer member consisting of an endless belt, a primary transfer device having a primary transfer roll made of a metal, and a secondary transfer device, in which the endless belt consists of a layer containing a resin and conductive carbon particles or has such a layer as an outermost layer, the transfer device further suppressing a ghost phenomenon resulting from charge conduction along an outer peripheral surface of the endless belt, compared to a transfer device in which the aforementioned layer does not contain a silicone oil or contains only a fluorine-modified silicone oil as a silicone oil or an integral value of a statistical quantity L(r) represented by the following Equation (1) is more than 0.1 at an interparticle distance r of 0.05 μm or more and 0.30 μm or less in a spatial distribution of the conductive carbon particles existing in a 6.3 μm×4.2 μm evaluation region within the outer peripheral surface of the endless belt.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

The above aspect is achieved by the following means.

According to an aspect of the present disclosure, there is provided a transfer device including an intermediate transfer member consisting of an endless belt which consists of a layer containing a resin including at least one resin selected from the group consisting of a polyimide resin, a polyamide-imide resin, an aromatic polyether ether ketone resin, a polyphenylene sulfide resin, and a polyetherimide resin, conductive carbon particles, a silicone oil containing at least one polymer selected from the group consisting of dimethylpolysiloxane and organic group-substituted dimethylpolysiloxane or has the layer as an outermost layer, and in which an integral value of a statistical quantity L(r) represented by the following Equation (1) is 0 or more and 0.1 or less at an interparticle distance r of 0.05 μm or more and 0.30 μm or less in a spatial distribution of the conductive carbon particles existing in a 6.3 μm×4.2 μm evaluation region within an outer peripheral surface of the endless belt,
a primary transfer device having a primary transfer roll made of a metal that applies an electric field to the intermediate transfer member by coming into contact with an inner peripheral surface of the intermediate transfer member, and performing primary transfer of a toner image formed on a surface of an image holder to the outer peripheral surface of the intermediate transfer member, and
a secondary transfer device performing secondary transfer of the toner image transferred to the outer peripheral surface of the intermediate transfer member to a surface of a recording medium.

$$L ( r ) := \sqrt{K ( r ) / π} - r \qquad ( 1 )$$

[In Equation (1), r represents the interparticle distance, and K(r) represents the Ripley's K function K(r) represented by the following Equation (2).]

$$K ( r ) := \frac{{\sum }_{i \neq j}^{N} 1 ( \vert {X}_{i} - {X}_{j} \vert \leq r ) / s ( \vert {X}_{i} - {X}_{j} \vert )}{{λ}^{2}} \qquad ( 2 )$$

[In Equation (2), 1(|Xᵢ−Xⱼ|≤r) represents an indicator function, Xᵢ and Xⱼ represent coordinates of points i and j respectively, |Xᵢ−Xⱼ| represents a Euclidean distance between the coordinates Xᵢ and Xⱼ, r represents the interparticle distance, s(|Xᵢ−Xⱼ|) represents an edge correction factor s(x) of an evaluation region represented by the following Equation (3), x equals |Xᵢ−Xⱼ|, N represents the total number of particles in the evaluation region, and X represents a number density of particles in the evaluation region.]

$$s ( x ) := {L}_{x} {L}_{y} - \frac{x}{π} ( 2 {L}_{x} + 2 {L}_{y} - x ) \qquad ( 3 )$$

[In Equation (3), Lₓ and L_{y} represent lengths (μm) of the sides of the evaluation region in an x-axis direction and a y-axis direction respectively, x equals |Xᵢ−Xⱼ|, Xᵢ and Xⱼ represent coordinates of points i and j respectively, and |Xᵢ−Xⱼ| represents a Euclidean distance between the coordinates Xᵢ and Xⱼ.]

### BRIEF DESCRIPTION OF THE DRAWINGS

Exemplary embodiment(s) of the present invention will be described in detail based on the following FIGURES, wherein:

FIG. 1 is a schematic configuration view showing an example of an image forming apparatus according to the present exemplary embodiment.

### DETAILED DESCRIPTION

The present exemplary embodiment will be described below. The following descriptions and examples merely illustrate exemplary embodiments, and do not limit the scope of the exemplary embodiments.

Regarding the ranges of numerical values described in stages in the present exemplary embodiment, the upper limit or lower limit of a range of numerical values may be replaced with the upper limit or lower limit of another range of numerical values described in stages. Furthermore, in the present exemplary embodiment, the upper limit or lower limit of a range of numerical values may be replaced with values described in examples.

In the present exemplary embodiment, the term “step” includes not only an independent step but a step which is not clearly distinguished from other steps as long as the intended goal of the step is achieved.

In the present exemplary embodiment, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present exemplary embodiment, each component may include two or more kinds of corresponding substances. In a case where the amount of each component in a composition is mentioned in the present exemplary embodiment, and there are two or more kinds of substances corresponding to each component in the composition, unless otherwise specified, the amount of each component means the total amount of two or more kinds of the substances present in the composition.

### Transfer Device

The transfer device according to the present exemplary embodiment includes an intermediate transfer member consisting of an endless belt which consists of a layer containing a resin including at least one resin selected from the group consisting of a polyimide resin, a polyamide-imide resin, an aromatic polyether ether ketone resin, a polyphenylene sulfide resin, and a polyetherimide resin, conductive carbon particles, a silicone oil containing at least one polymer selected from the group consisting of dimethylpolysiloxane and organic group-substituted dimethylpolysiloxane or has the layer as an outermost layer, and in which an integral value of a statistical quantity L(r) represented by the following Equation (1) is 0 or more and 0.1 or less at an interparticle distance r of 0.05 μm or more and 0.30 μm or less in a spatial distribution of the conductive carbon particles existing in a 6.3 μm×4.2 μm evaluation region within an outer peripheral surface of the endless belt, a primary transfer device having a primary transfer roll made of a metal that applies an electric field to the intermediate transfer member by coming into contact with an inner peripheral surface of the intermediate transfer member, and performing primary transfer of a toner image formed on a surface of an image holder to the outer peripheral surface of the intermediate transfer member, and a secondary transfer device performing secondary transfer of the toner image transferred to the outer peripheral surface of the intermediate transfer member to a surface of a recording medium.

$$L ( r ) := \sqrt{K ( r ) / π} - r \qquad ( 1 )$$

[In Equation (1), r represents the interparticle distance, and K(r) represents the Ripley's K function K(r) represented by the following Equation (2).]

$$K ( r ) := \frac{{\sum }_{i \neq j}^{N} 1 ( \vert {X}_{i} - {X}_{j} \vert \leq r ) / s ( \vert {X}_{i} - {X}_{j} \vert )}{{λ}^{2}} \qquad ( 2 )$$

[In Equation (2), 1(|Xᵢ−Xⱼ|≤r) represents an indicator function, Xᵢ and Xⱼ represent coordinates of points i and j respectively, |Xᵢ−Xⱼ| represents a Euclidean distance between the coordinates Xᵢ and Xⱼ, r represents the interparticle distance, s(|Xᵢ−Xⱼ|) represents an edge correction factor s(x) of an evaluation region represented by the following Equation (3), x equals |Xᵢ−Xⱼ|, N represents the total number of particles in the evaluation region, and X represents a number density of particles in the evaluation region.]

$$s ( x ) := {L}_{x} {L}_{y} - \frac{x}{π} ( 2 {L}_{x} + 2 {L}_{y} - x ) \qquad ( 3 )$$

[In Equation (3), Lₓ and L_{y} represent lengths (μm) of the sides of the evaluation region in an x-axis direction and a y-axis direction respectively, x equals |Xᵢ−Xⱼ|, Xᵢ and Xⱼ represent coordinates of points i and j respectively, and |Xᵢ−Xⱼ| represents a Euclidean distance between the coordinates Xᵢ and Xⱼ.]

Hereinafter, the resin including at least one resin selected from the group consisting of a polyimide resin, a polyamide-imide resin, an aromatic polyether ether ketone resin, a polyphenylene sulfide resin, and a polyetherimide resin will be also called “first resin”.

Furthermore, at least one polymer selected from the group consisting of dimethylpolysiloxane and an organic group-substituted dimethylpolysiloxane will be also called “specific silicone oil”.

In addition, the layer configuring the outer peripheral surface of the endless belt will be also called “outer peripheral layer”.

Moreover, the integral value of a statistical quantity L(r) represented by Equation (1) at an interparticle distance r of 0.05 μm or more and 0.30 μm or less in a spatial distribution of the conductive carbon particles existing in a 6.3 μm×4.2 μm evaluation region within the outer peripheral surface of the endless belt will be also called “L(r) integral value”.

Note that “conductive” means that a volume resistivity at 20° C. is less than 1×10¹³ Ωcm.

In the transfer device having an intermediate transfer member consisting of an endless belt, a primary transfer device having a primary transfer roll made of a metal, and a secondary transfer device, as described above, because the primary transfer roll made of a metal is rigid and has high conductivity, the ghost phenomenon easily occurs.

Specifically, because the primary transfer roll made of a metal is rigid, the circumferential width of a region (hereinafter, also called “nip region”) where the intermediate transfer member is pinched between the image holder and the primary transfer roll is narrowed. The endless belt comes into contact with the highly conductive primary transfer roll in the nip region having a narrow circumferential width, which makes it easy for charge to be conducted along the outer peripheral surface of the endless belt in the axial direction of the primary transfer roll. In a case where the charge is conducted along the surface, sometimes the electric field between the endless belt and the image holder is applied obliquely, resulting in the deviation of a toner image from the transfer position. At this time, in a case where the circumferential width of the nip region is narrow, the endless belt passes through the nip region within a short time. Accordingly, toner scattering is likely to occur, and the ghost phenomenon easily occurs due to the toner scattering.

Particularly, in a case where a second toner image formed on a second image holder is subjected to primary transfer by being superposed on the first toner image which has been transferred to the outer peripheral surface of the endless belt by primary transfer, it is more likely that the electric field between the endless belt and the second image holder will be applied obliquely by being influenced by the charge that the first toner image on the endless belt carries, which sometimes leads to a marked ghost phenomenon.

On the other hand, in the present exemplary embodiment, the outer peripheral layer contains the specific silicone oil, and the L(r) integral value in the outer peripheral layer is 0 or more and 0.1 or less, resulting in the suppression of the ghost phenomenon. The reason is unclear, but is presumed as follows.

The L(r) integral value of 0 or more and 0.1 or less in the outer peripheral layer means that the conductive carbon particles are finely dispersed on the outer peripheral surface of the endless belt. Therefore, because the current is dispersed by the conductive carbon particles finely dispersed on the outer peripheral surface of the endless belt, the charge is inhibited from being conducted along the surface in the axial direction of the primary transfer roll even though the primary transfer roll made of a metal comes into contact with the inner peripheral surface of the endless belt. In addition, presumably, because the outer peripheral layer of the endless belt contains the specific silicone oil, non-electrostatic adhesion of the outer peripheral surface may be reduced, a toner may be easily peeled off even being scattered and adhering to a region where an image is not supposed to be formed, and the ghost phenomenon may be suppressed.

### Intermediate Transfer Member

The intermediate transfer member consists of an endless belt.

The endless belt may be a single layer structure or a laminate.

In a case where the endless belt is a single layer structure, the single layer structure is the outer peripheral layer that contains the first resin, the conductive carbon particles, and the specific silicone oil and has the L(r) integral value of 0 or more and 0.1 or less. Hereinafter, the conductive carbon particles contained in the outer peripheral layer will be also called “first conductive carbon particles”, and the single layer structure that is the outer peripheral layer will be also called “single layer”.

In a case where the endless belt is a laminate, the laminate has, for example, a substrate layer and a surface layer that is an outermost layer provided on the substrate layer. The laminate may have another layer between the substrate layer and the surface layer. In a case where the endless belt is a laminate having the substrate layer and the surface layer, the surface layer is the outer peripheral layer that contains the first resin, first conductive carbon particles, and the specific silicone oil and has the L(r) integral value of 0 or more and 0.1 or less. Hereinafter, the surface layer which is the outer peripheral layer will be also called “first layer”.

In a case where the endless belt is a laminate having the substrate layer and the surface layer, the substrate layer is not particularly limited, and examples thereof include a layer containing a second resin that will be described later and second conductive carbon particles that will be described later. Hereinafter, the substrate layer will be also called “second layer”.

### Resin

The first resin contained in the outer peripheral layer contains at least one resin selected from the group consisting of a polyimide resin (PI resin), a polyamide-imide resin (PAI resin), an aromatic polyether ether ketone resin (PEEK resin), a polyphenylene sulfide resin (PPS resin), and a polyetherimide resin (PEI resin). The first resin may be a resin consisting of one resin or a mixture of two or more resins.

The first resin may contain other resins. The total content of the polyimide resin, the polyamide-imide resin, the aromatic polyether ether ketone resin, the polyphenylene sulfide resin, and the polyetherimide resin with respect to the entire first resin is, for example, preferably 80% by mass or more, more preferably 90% by mass or more, and even more preferably 95% by mass or more. Examples of other resins include an aromatic polyether ketone resin other than the PEEK resin, a polyester resin, a polyamide resin, a polycarbonate resin, and the like.

From the viewpoint of causing the ghost phenomenon to remain suppressed, the first resin preferably contains, for example, an imide-based resin. It is unclear why the ghost phenomenon remains suppressed in a case where the first resin contains an imide-based resin. Presumably, because the imide-based resin is rigid, the specific silicone oil is likely to stay in a region close to the outer peripheral surface of the endless belt, the ghost phenomenon may remain suppressed. In a case where the first resin contains the imide-based resin, the total content of the imide-based resin with respect to the entire first resin is, for example, preferably 80% by mass or more, more preferably 90% by mass or more, and even more preferably 95% by mass or more.

Examples of the imide-based resin include a polyimide resin, a polyamide-imide resin, and a polyetherimide resin. From the viewpoint of causing the ghost phenomenon to remain suppressed, for example, the first resin more preferably contains at least one resin selected from the group consisting of a polyimide resin and a polyamide-imide resin, and even more preferably contains a polyimide resin, among imide-based resins.

Examples of the second resin contained in the substrate layer include a polyimide resin, a polyamide-imide resin, an aromatic polyether ketone resin, a polyphenylene sulfide resin, a polyetherimide resin, a polyester resin, a polyamide resin, a polycarbonate resin, and the like. The second resin may be a resin consisting of one resin or a mixture of two or more resins.

In a case where the endless belt has the first layer and the second layer, the first resin and the second resin may be the same resin or different resins. For example, it is preferable that the first and second resins be the same resin (for example, it is preferable that both the first and second resins be a polyimide resin).

### Polyimide Resin

Examples of the polyimide resin include an imidized polyamic acid (polyimide resin precursor) which is a polymer of a tetracarboxylic dianhydride and a diamine compound.

Examples of the polyimide resin include a resin having a constitutional unit represented by General Formula (I).

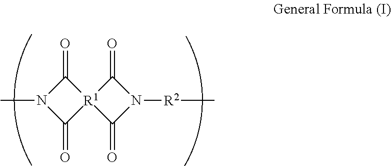

In General Formula (I), R¹ represents a tetravalent organic group, and R² represents a divalent organic group.

Examples of the tetravalent organic group represented by R¹ include an aromatic group, an aliphatic group, a cyclic aliphatic group, a group obtained by combining an aromatic group and an aliphatic group, and a group obtained by the substitution of these. Specific examples of the tetravalent organic group include a residue of a tetracarboxylic dianhydride which will be described later.

Examples of the divalent organic group represented by R² include an aromatic group, an aliphatic group, a cyclic aliphatic group, a group obtained by combining an aromatic group and an aliphatic group, and a group obtained by the substitution of these. Specific examples of the divalent organic group include a residue of a diamine compound which will be described later.

Specifically, examples of the tetracarboxylic dianhydride used as a raw material of the polyimide resin include a pyromellitic dianhydride, a 3,3′,4,4′-benzophenone tetracarboxylic dianhydride, a 3,3′,4,4′-biphenyltetracarboxylic dianhydride, a 2,3,3′,4-biphenyltetracarboxylic dianhydride, a 2,3,6,7-naphthalenetetracarboxylic dianhydride, a 1,2,5,6-naphthalenetetracarboxylic dianhydride, a 1,4,5,8-naphthalenetetracarboxylic dianhydride, a 2,2′-bis(3,4-dicarboxyphenyl)sulfonic dianhydride, a perylene-3,4,9,10-Tetracarboxylic dianhydride, a bis(3,4-dicarboxyphenyl)ether dianhydride, and an ethylenetetracarboxylic dianhydride.

Specific examples of the diamine compound used as a raw material of the polyimide resin include 4,4′-diaminodiphenyl ether, 4,4′-diaminodiphenylmethane, 3,3′-diaminodiphenylmethane, 3,3′-dichlorobenzidine, 4,4′-diaminodiphenylsulfide, 3,3′-diaminodiphenylsulfone, 1,5-diaminonaphthalene, m-phenylenediamine, p-phenylenediamine, 3,3′-dimethyl 4,4′-biphenyldiamine, benzidine, 3,3′-dimethylbenzidine, 3,3′-dimethoxybenzidine, 4,4′-diaminodiphenylsulfone, 4,4′-diaminodiphenylpropane, 2,4-bis(3-amino tert-butyl)toluene, bis(p-β-amino-tert-butylphenyl)ether, bis(p-β-methyl-δ-aminophenyl)benzene, bis-p-(1,1-dimethyl-5-amino-pentyl) benzene, 1-isopropyl-2,4-m-phenylenediamine, m-xylylene diamine, p-xylylene diamine, di(p-aminocyclohexyl)methane, hexamethylenediamine, heptamethylenediamine, octamethylenediamine, nonamethylenediamine, decamethylenediamine, diaminopropyltetramethylenediamine, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,17-diaminoeicosadecane, 1,4-diaminocyclohexane, 1,10-diamino-1,10-dimethyldecane, 12-diaminooctadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, H₂N(CH₂)₃N(CH₃)₂(CH₂)₃NH₂, and the like.

### Polyamide-Imide Resin

Examples of the polyamide-imide resin include a resin having an imide bond and an amide bond in a repeating unit.

More specifically, examples of the polyamide-imide resin include a polymer of a trivalent carboxylic acid compound (also called a tricarboxylic acid) having an acid anhydride group and a diisocyanate compound or a diamine compound.

As the tricarboxylic acid, for example, a trimellitic acid anhydride and a derivative thereof preferable. In addition to the tricarboxylic acid, a tetracarboxylic dianhydride, an aliphatic dicarboxylic acid, an aromatic dicarboxylic acid, or the like may also be used.

Examples of the diisocyanate compound include 3,3′-dimethylbiphenyl-4,4′-diisocyanate, 2,2′-dimethylbiphenyl-4,4′-diisocyanate, biphenyl-4,4′-diisocyanate, biphenyl-3,3′-diisocyanate, biphenyl-3,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, and naphthalene-2,6-diisocyanate.

Examples of the diamine compound include a compound that has the same structure as the aforementioned isocyanate and has an amino group instead of an isocyanato group.

### Aromatic Polyether Ether Ketone Resin

Examples of the aromatic polyether ether ketone resin include a resin in which aromatic rings such as benzene rings are linearly bonded to each other by ether bonds and ketone bonds that are arranged in order of an ether bond, an ether bond, and a ketone bond.

### Polyphenylene Sulfide Resin

Examples of the polyphenylene sulfide resin include a resin in which a group having a benzene ring and a sulfur atom are alternately bonded to each other.

Examples of the group having a benzene ring include p-phenylene, m-phenylene, o-phenylene, alkyl-substituted phenylene, phenyl-substituted phenylene, halogen-substituted phenylene, amino-substituted phenylene, amide-substituted phenylene, and the like.

### Polyetherimide Resin

Examples of the polyetherimide resin include a polymer of an aromatic bis(etherdicarboxylic)acid and a diamine.

Examples of the aromatic bis(etherdicarboxylic) acid include 2,2-bis[4-(2,3-dicarboxyphenoxy)phenyl]propane, 2,2-bis[4-(3,4-dicarboxyphenoxy)phenyl]propane, and the like.

Examples of the diamine include 4,4′-diaminodiphenylmethane, metaphenylenediamine, and the like.

In the endless belt that is a single layer structure, from the viewpoint of mechanical strength, volume resistivity adjustment, and the like, the content of the first resin with respect to the entire single layer that is the outer peripheral layer is, for example, preferably 48% by mass or more and 91% by mass or less, more preferably 55% by mass or more and 89% by mass or less, and even more preferably 65% by mass or more and 84% by mass or less.

In the endless belt that is a laminate, from the viewpoint of mechanical strength, volume resistivity adjustment, and the like, the content of the first resin with respect to the entire first layer that is the outer peripheral layer is, for example, preferably 48% by mass or more and 91% by mass or less, more preferably 55% by mass or more and 89% by mass or less, and even more preferably 65% by mass or more and 84% by mass or less.

In the endless belt that is a laminate, from the viewpoint of mechanical strength, volume resistivity adjustment, and the like, the content of the second resin with respect to the entire second layer is, for example, preferably 60% by mass or more and 95% by mass or less, more preferably 70% by mass or more and 90% by mass or less, and even more preferably 70% by mass or more and 80% by mass or less.

### Conductive Carbon Particles

Examples of the first conductive carbon particles contained in the outer peripheral layer include carbon black.

Examples of the carbon black include Ketjen black, oil furnace black, channel black, and acetylene black. As the carbon black, carbon black having undergone a surface treatment (hereinafter, also called “surface-treated carbon black”) may be used.

The surface-treated carbon black is obtained by adding, for example, a carboxy group, a quinone group, a lactone group, or a hydroxy group to the surface of carbon black. Examples of the surface treatment method include an air oxidation method of reacting carbon black by bringing the carbon black into contact with air in a high temperature atmosphere, a method of reacting carbon black with nitrogen oxide or ozone at room temperature (for example, 22° C.), and a method of oxidizing carbon black with air in a high temperature atmosphere and then with ozone at a low temperature.

The number-average primary particle size of the first conductive carbon particles is, for example, in a range of 20 nm or less. From the viewpoint of adjusting the L(r) integral value to the above range, the number-average primary particle size of the first conductive carbon particles is, for example, preferably in a range of 18 nm or less, more preferable in a range of 15 nm or less, and even more preferably in a range of 13 nm or less. Furthermore, the number-average primary particle size of the first conductive carbon particles is, for example, in a range of 2 nm or more. From the viewpoint of adjusting the L(r) integral value to the above range, the number-average primary particle size of the first conductive carbon particles is, for example, preferably in a range of 5 nm or more, and more preferable in a range of 10 nm or more.

The number-average primary particle size of the conductive carbon particles is measured by the following method.

First, by a microtome, a measurement sample having a thickness of 100 nm is collected from each layer of the obtained belt and observed with a transmission electron microscope (TEM). Then, the diameters of circles each having an area equivalent to the projected area of each of 50 conductive carbon particles (that is, equivalent circle diameters) are adopted as particle sizes, and the average thereof are adopted as the number-average primary particle size.

In a case where the first resin contains at least one resin selected from the group consisting of a polyimide resin and a polyamide-imide resin, and the outer peripheral layer is formed of a first coating liquid that will be described later, from the viewpoint of adjusting the L(r) integral value to the aforementioned range, as the first conductive carbon particles, among the above, for example, channel black is preferable, and channel black whose having undergone a surface treatment is more preferable.

In a case where the outer peripheral layer is formed of the first coating liquid, the pH of the first conductive carbon particles is, for example, in a range of 1.0 or more and 5.5 or less. From the viewpoint of adjusting the L(r) integral value to the aforementioned range, the pH of the first conductive carbon particles is, for example, preferably in a range of 1.0 or more and 3.0 or less.

In a case where the first resin contains at least one resin selected from the group consisting of a polyetherimide resin, an aromatic polyether ether ketone resin, and a polyphenylene sulfide resin, and the outer peripheral layer is formed by melt extrusion that will be described later, from the viewpoint of adjusting the L(r) integral value to the aforementioned range, as the first conductive carbon particles, among the above, for example, channel black and furnace black are preferable, and channel black or furnace black not being subjected to surface treatment is more preferable.

The first conductive carbon particles may be particles consisting of one kind of conductive carbon particles or a mixture of two or more kinds of conductive carbon particles.

In the endless belt that is a single layer structure, from the viewpoint of reducing the L(r) integral value and from the viewpoint of ensuring strength, the content of the first conductive carbon particles with respect to the entire single layer that is the outer peripheral layer is, for example, preferably 8% by mass or more and 45% by mass or less, more preferably 10% by mass or more and 38% by mass or less, and even more preferably 13% by mass or more and 30% by mass or less.

In the endless belt that is a laminate, from the viewpoint of reducing the L(r) integral value and from the viewpoint of ensuring strength, the content of the first conductive carbon particles with respect to the entire first layer that is the outer peripheral layer is, for example, preferably 8% by mass or more and 45% by mass or less, more preferably 10% by mass or more and 38% by mass or less, and even more preferably 13% by mass or more and 30% by mass or less.

Specific examples of the second conductive carbon particles contained in the second layer of the endless belt that is a laminate are the same as the specific examples of the first conductive carbon particles.

The number-average primary particle size of the second conductive carbon particles is, for example, in a range of 2 nm or more and 40 nm or less. From the viewpoint of dispersibility, mechanical strength, volume resistivity, film forming properties, and the like, the number-average particle size of the second conductive carbon particles is, for example, preferably in a range of 20 nm or more and 40 nm or less, more preferably in a range of 20 nm or more and 35 nm or less, and even more preferably in a range of 20 nm or more and 28 nm or less.

In a case where the endless belt has the first layer and the second layer, the number-average primary particle size of the first conductive carbon particles is, for example, preferably smaller than the number-average primary particle size of the second conductive carbon particles. The number-average primary particle size of the first conductive carbon particles is, for example, preferably equal to or more than 0.5 times and less than 1.0 times the number-average primary particle size of the second conductive carbon particles, more preferably equal to or more than 0.5 times and equal to or less than 0.8 times the number-average primary particle size of the second conductive carbon particles, and even more preferably equal to or more than 0.5 times and equal to or less than 0.7 times the number-average primary particle size of the second conductive carbon particles.

In a case where the substrate layer of the endless belt that is a laminate is formed of a second coating liquid which will be described later, the pH of the second conductive carbon particles is, for example, in a range of 1.0 or more and 5.5 or less. From the viewpoint of adjusting the L(r) integral value to the aforementioned range, the pH of the second conductive carbon particles is, for example, preferably in a range of 1.0 or more and 3.0 or less.

In a case where the endless belt has the first layer formed of the first coating liquid and the second layer formed of the second coating liquid, the pH of the first conductive carbon particles is, for example, preferably lower than the pH of the second conductive carbon particles.

In the endless belt that is a laminate, from the viewpoint of dispersibility, mechanical strength and volume resistivity adjustment, the content of the second conductive carbon particles with respect to the entire substrate layer is, for example, preferably 5% by mass or more and 40% by mass or less, more preferably 10% by mass or more and 30% by mass or less, and even more preferably 20% by mass or more and 30% by mass or less.

### Silicone Oil

The silicone oil contained in the outer peripheral layer contains the specific silicone oil, that is, at least one polymer selected from the group consisting of dimethylpolysiloxane and an organic group-substituted dimethylpolysiloxane.

“Organic group-substituted dimethylpolysiloxane” refers to a compound in which at least some of methyl groups of dimethylpolysiloxane are substituted with an organic group.

The organic group is not particularly limited as long as it is a group having a carbon atom. Examples of the organic group include a group which has at least one group selected from the group consisting of an alkyl group, an amino group, an epoxy group, an alicyclic epoxy group, a hydroxy group, a carboxy group, a mercapto group, a phenyl group, a vinyl group, an alkylene group, a carbonyl group, an ether bond, a thioether bond, an ester bond, and an amide bond and has one or more carbon atoms.

From the viewpoint of suppressing the ghost phenomenon, the number of carbon atoms contained in the organic group is, for example, preferably 3 or more, more preferably 6 or more, and even more preferably 8 or more. Furthermore, from the viewpoint of keep suppressing the ghost phenomenon, the number of carbon atoms contained in the organic group is, for example, preferably 12 or less, more preferably 10 or less, and even more preferably 8 or less.

The organic group-substituted dimethylpolysiloxane may be a side-chain type modified silicone oil in which an organic group is bonded as a side chain of dimethylpolysiloxane, a single-end type modified silicone oil in which an organic group is bonded to one end of dimethylpolysiloxane, a dual-end type modified silicone oil in which an organic group is bonded to both ends of dimethylpolysiloxane, or a side-chain dual-end type modified silicone oil in which an organic group is bonded to side chains and both ends of dimethylpolysiloxane. As the organic group-substituted dimethylpolysiloxane, from the viewpoint of suppressing the ghost phenomenon, for example, the side-chain type modified silicone oil, the dual-end type modified silicone oil, and the side-chain dual-end type silicone oil are preferable, and the dual end-type modified silicone oil is more preferable.

Examples of the organic group-substituted dimethylpolysiloxane include a polyether-modified silicone oil, a long-chain alkyl-modified silicone oil, an epoxy-modified silicone oil, an amino-modified silicone oil, a carbinol-modified silicone oil, a mercapto-modified silicone oil, a carboxyl-modified silicone oil, a methacryl-modified silicone oil, an acryl-modified silicone oil, a carboxylic anhydride-modified silicone oil, an aralkyl-modified silicone oil, a fluoroalkyl-modified silicone oil, a higher fatty acid ester-modified silicone oil, a higher fatty acid amide-modified silicone oil, a phenyl-modified silicone oil, and the like.

As the organic group-substituted dimethylpolysiloxane, from the viewpoint of causing the ghost phenomenon to remain suppressed, for example, a polyether-modified silicone oil and a long-chain alkyl-modified silicone oil are preferable, and a polyether-modified silicone oil is more preferable. It is unclear why the use of the polyether-modified alkyl silicone oil as the organic group-substituted dimethylpolysiloxane further suppresses the ghost phenomenon. Presumably, because the existence of polyether groups makes it easy for the silicone oil to remain aligned on the outer peripheral surface side of the endless belt, the ghost phenomenon may be further suppressed.

In addition, from the viewpoint of further suppressing the ghost phenomenon, the organic group-substituted dimethylpolysiloxane is, for example, preferably a compound having a cyclic siloxane structure. The cyclic siloxane structure is considered to affect the alignment state of the compound on the outer peripheral surface side of the endless belt. Presumably, therefore, using a compound having no cyclic siloxane structure as the organic group-substituted dimethylpolysiloxane may further suppress the ghost phenomenon than using a compound having a cyclic siloxane structure.

From the viewpoint of causing the ghost phenomenon remain suppressed, as a combination of the resin and the silicone oil contained in the outer peripheral layer, for example, a combination of the first resin containing an imide-based resin and a silicone oil containing polyether-modified silicone oil is preferable. Particularly, for example, a combination of the first resin containing a polyimide resin and the silicone oil containing a polyether-modified silicone oil is more preferable, and a combination of the first resin containing a polyimide resin and the silicone oil containing a polyether-modified silicone oil having no cyclic siloxane structure is even more preferable. It is unclear why combining the imide-based resin and the polyether-modified silicone oil causes the ghost phenomenon to remain suppressed. Presumably, because the steric hindrance between the polyether group of the silicone oil and the imide-based resin makes it easy for the silicone oil to remain aligned on the outer peripheral surface side of the endless belt, the ghost phenomenon may remain suppressed.

The number-average molecular weight of the specific silicone oil is not particularly limited and may be, for example, 50 or more and 2,000 or less. From the viewpoint of suppressing the ghost phenomenon, the number-average molecular weight of the specific silicone oil is, for example, preferably 100 or more and 1,500 or less, and more preferably 200 or more and 1,200 or less.

The number-average molecular weight of the silicone oil is measured by gel permeation chromatography (GPC). By GPC, the molecular weight is measured in a tetrahydrofuran (THF) solvent by using GPC·HLC-8120GPC manufactured by Tosoh Corporation as a measurement device and TSKgel·Super HM-M (15 cm) manufactured by Tosoh Corporation as a column. The number-average molecular weight is calculated using a molecular weight calibration curve created by a monodisperse polystyrene standard sample based on the measurement results.

The viscosity of the specific silicone oil at 20° C. is not particularly limited, and is, for example, 0.1 mPa·s or more and 100 mPa·s or less. From the viewpoint of suppressing the ghost phenomenon, the viscosity of the specific silicone oil at 20° C. is, for example, preferably 0.1 mPa·s or more and 50 mPa·s or less, and more preferably 0.1 mPa·s or more and 20 mPa·s or less.

The viscosity of the silicone oil is measured using a B-8L type viscometer manufactured by TOKYO KEIKI.

The silicone oil contains at least the specific silicone oil, and may or may not contain a silicone oil other than the specific silicone oil. The ratio of the specific silicone oil to the entire silicone oil is, for example, preferably 80% by mass or more, more preferably 90% by mass or more, and even more preferably 95% by mass or more.

Examples of the silicone oil other than the specific silicone oil include a fluorine-modified silicone oil, a methyl hydrogen silicone oil, a silanol-modified silicone oil, and the like.

In the endless belt that is a single layer structure, the content of the silicone oil with respect to the entire single layer which is the outer peripheral layer is, for example, preferably 1% by mass or more and 7% by mass or less, and more preferably 3% by mass or more and 5% by mass or less.

In the endless belt that is a laminate, the content of the silicone oil with respect to the entire first layer which is the outer peripheral layer is, for example, preferably 1% by mass or more and 7% by mass or less, and more preferably 3% by mass or more and 5% by mass or less.

In a case where the content of the silicone oil with respect to the entire outer peripheral layer is in the above range, the silicone oil is more likely to bring about the effect of reducing non-electrostatic adhesion of the outer peripheral surface of the endless belt, and the ghost phenomenon is further suppressed, compared to a case where the content of the silicone oil is lower than the above range. Furthermore, in a case where the content of the silicone oil with respect to the entire outer peripheral layer is in the above range, the deterioration of the effect of reducing non-electrostatic adhesion resulting from the aggregation of the silicone oil is likely to be further prevented, and the ghost phenomenon is further suppressed, compared to a case where the content of the silicone oil is higher than the above range.

### Other Components

The outer peripheral layer may contain other components in addition to the first resin, the first conductive carbon particles, and the silicone oil. Furthermore, the second layer of the endless belt that is a laminate may contain other components in addition to the second resin and the second conductive carbon particles.

In the endless belt that is a single layer structure, the total content of the first resin, the first conductive carbon particles, and the silicone oil with respect to the entire single layer which is the outer peripheral layer is, for example, preferably 80% by mass or more, more preferably 90% by mass or more, and even more preferably 95% by mass or more. In the endless belt that is a laminate, the total content of the first resin, the first conductive carbon particles, and the silicone oil with respect to the entire first layer which is the outer peripheral layer is, for example, preferably 80% by mass or more, more preferably 90% by mass or more, and even more preferably 95% by mass or more. In addition, in the endless belt that is a laminate, the total content of the second resin and the second conductive carbon particles with respect to the entire second layer is, for example, preferably 80% by mass or more, more preferably 90% by mass or more, and even more preferably 95% by mass or more.

Examples of the aforementioned other components include a conducting agent other than conductive carbon particles, a filler for improving the strength of the belt, an antioxidant for preventing thermal deterioration of a belt, a surfactant for improving fluidity, a heat-resistant antioxidant, and the like.

### Characteristics of Endless Belt

### L(r) Integral Value

The L(r) integral value within the outer peripheral surface of the endless belt is 0 or more and 0.1 or less. From the viewpoint of suppressing the ghost phenomenon, the L(r) integral value is, for example, preferably 0 or more and 0.08 or less, and more preferably 0 or more and 0.06 or less.

The spatial distribution of the conductive carbon particles is obtained by observing the outer peripheral surface of the endless belt with a scanning electron microscope (for example, manufactured by Hitachi High-Tech Corporation., model number: SU8010) at 20,000× magnification, and performing binarization processing on the obtained 256-level grayscale image at a threshold value of 128 by using analysis software (for example, free software “Image J”) as necessary. Then, a statistical quantity L(r) at an interparticle distance r of 0.05 μm or more and 0.30 μm or less is calculated at intervals of 0.05 μm based on the above equation, and an integral value in a range of 0.05 μm or more and 0.30 μm or less is determined and adopted as “L(r) integral value”.

The method of making the L(r) integral value fall into the above range is not particularly limited, and examples thereof include a method of using conductive carbon particles having a small number-average primary particle size, a method of selecting the type of conductive carbon particles to be used, a method of adjusting the conditions (for example, drying conditions and the like) in the manufacturing process of the endless belt, and the like.

### Thickness of Endless Belt

Regarding the endless belt that is a single layer structure, from the viewpoint of mechanical strength of the belt, the thickness of the single layer is, for example, preferably 60 μm or more and 120 μm or less, and more preferably 80 μm or more and 120 μm or less.

Regarding the endless belt that is a laminate, from the viewpoint of manufacturing suitability and suppression of ghost phenomenon, the thickness of the first layer is, for example, preferably 1 μm or more and 60 μm or less, and more preferably 3 μm or more and 60 μm or less.

Regarding the endless belt that is a laminate, from the viewpoint of mechanical strength of the belt, the thickness of the second layer is, for example, preferably 10 μm or more and 80 μm or less, and more preferably 20 μm or more and 40 μm or less.

In a case where the endless belt has the first layer and the second layer, from the viewpoint of suppressing the ghost phenomenon, the ratio of the outer peripheral layer to the total thickness is, for example, preferably 3% or more and 90% or less, and more preferably 5% or more and 80% or less.

The film thickness of each layer is measured as follows.

That is, a cross section of the endless belt taken along the thickness direction is observed with an optical microscope or a scanning electron microscope, the thickness of a layer as a measurement target is measured at 10 sites, and the average thereof is adopted as the thickness.

### Volume Resistivity of Endless Belt

From the viewpoint of improving transferability, the common logarithm of the volume resistivity that the endless belt has in a case where a voltage of 500 V is applied thereto for 10 seconds is, for example, preferably 9.0 (log Ω·cm) or more and 13.5 (log Ω·cm) or less, more preferably 9.5 (log Ω·cm) or more and 13.2 (log Ω·cm) or less, and particularly preferably 10.0 (log Ω·cm) or more and 12.5 (log Ω·cm) or less.

The volume resistivity that the endless belt has in a case where a voltage of 500 V is applied thereto for 10 seconds is measured by the following method.

By using a microammeter (R8430A manufactured by ADVANTEST CORPORATION) as a resistance meter and a UR probe (manufactured by Mitsubishi Chemical Analytech Co., Ltd.) as a probe, the volume resistivity (log Ω·cm) is measured at a total of 18 spots in the endless belt, 6 spots at equal intervals in the circumferential direction and 3 spots in the central portions and both end portions in the width direction, at a voltage of 500 V under a pressure of 1 kgf for a voltage application time of 10 seconds, and the average thereof is calculated. The surface resistivity is measured in an environment of a temperature of 22° C. and a humidity of 55% RH.

### Surface Resistivity of Endless Belt

From the viewpoint of improving transferability, the common logarithm of the surface resistivity that the endless belt has in a case where a voltage of 500 V is applied to the outer peripheral surface thereof for 10 seconds is, for example, preferably 9.5 (log Ω/suq.) or more 15.0 (log Ω/suq.) or less, more preferably 10.0 (log Ω/suq.) or more and 14.0 (log Ω/suq.) or less, and particularly preferably 11.0 (log Ω/suq.) or more and 13.5 (log Ω/suq.) or less.

The unit of the surface resistivity, log Ω/suq, expresses the surface resistivity in a logarithm of resistance per unit area, which is also written as log(Ω/suq.), Log Ω/suquare, log Ω/□, or the like.

The surface resistivity that the endless belt has in a case where a voltage of 500 V is applied to the outer peripheral surface thereof for 10 seconds is measured by the following method.

By using a microammeter (R8430A manufactured by ADVANTEST CORPORATION) as a resistance meter and a UR probe (manufactured by Mitsubishi Chemical Analytech Co., Ltd.) as a probe, the surface resistivity (log Ω/suq.) of the outer peripheral surface of the endless belt is measured at a total of 18 spots within the outer peripheral surface of the endless belt, 6 spots at equal intervals in the circumferential direction and 3 spots in the central portions and both end portions in the width direction, at a voltage of 500 V under a pressure of 1 kgf for a voltage application time of 10 seconds, and the average thereof is calculated. The surface resistivity is measured in an environment of a temperature of 22° C. and a humidity of 55% RH.

### Manufacturing Method of Endless Belt

The manufacturing method of the endless belt according to the present exemplary embodiment is not particularly limited.

For example, the manufacturing method of the endless belt goes through a first coating liquid-preparing step of preparing a first coating liquid containing a first resin or a precursor thereof, first conductive carbon particles, a specific silicone oil, and a first solvent, a first coating film-forming step of forming a first coating film by coating the outer periphery of a material as a coating target with the first coating liquid, and a first drying step of drying the first coating film while increasing the temperature of the material as a coating target. The manufacturing method of the endless belt may go through other steps, in addition to the first coating liquid-preparing step, the first coating film-forming step, and the first drying step. For example, in a case where the first resin precursor is used, examples of such other steps include a first baking step of baking the first coating film dried by the first drying step, and the like.

In a case where an endless belt that is a single layer structure is to be manufactured, through the first coating liquid-preparing step, the first coating film-forming step, and the first drying step, a single layer which is an outer peripheral layer containing the first resin, the first conductive carbon particles, and the specific silicone oil is formed on the outer peripheral surface of the material as a coating target. The single layer may be formed, for example, by preparing pellets containing the first resin, the first conductive carbon particles, and the specific silicone oil, and subjecting the pellets to melt extrusion.

In a case where en endless belt that is a laminate is to be manufactured, through the first coating liquid-preparing step, the first coating film-forming step, and the first drying step, the first layer which is an outer peripheral layer containing the first resin, the first conductive carbon particles, and the specific silicone oil is formed on the outer peripheral surface of the second layer formed on the material as a coating target.

In a case where the endless belt that is a laminate is to be manufactured, for example, through a second coating liquid-preparing step of preparing a second coating liquid containing a second resin or a precursor thereof, second conductive carbon particles, and a second solvent, a second coating film-forming step of forming a second coating film by coating the outer periphery of a material as a coating target with the second coating liquid, and a second drying step of drying the second coating film, the second layer is formed on the outer peripheral surface of the material as a coating target. The second layer may be formed, for example, by preparing pellets containing the second resin and the second conductive carbon particles, and subjecting the pellets to melt extrusion.

Coating Liquid-Preparing step

In the first coating liquid-preparing step, the first coating liquid containing the first resin or a precursor thereof, the first conductive carbon particles, the specific silicone oil, and the first solvent is prepared. For example, in a case where the first resin is a polyimide resin and the first conductive carbon particles are carbon black, as the first coating liquid, for instance, a solution is prepared which contains dispersed carbon black and the first solvent in which a polyamic acid as a precursor of a polyimide resin and the specific silicone oil are dissolved. Furthermore, for example, in a case where the first resin is a polyamide-imide resin and the first conductive carbon particles are carbon black, as the first coating liquid, for instance, a solution is prepared which contains dispersed carbon black and the first solvent in which a polyamide-imide resin and the specific silicone oil are dissolved.

As a method of preparing the first coating liquid, from the viewpoint of pulverizing aggregates of the first conductive carbon particles and from the viewpoint of improving the dispersibility of the first conductive carbon particles, for example, it is preferable to perform a dispersion treatment by using a pulverizer such as a ball mill or a jet mill.

Furthermore, in the first coating liquid-preparing step, from the viewpoint of improving dispersibility of the first conductive carbon particles, for example, it is preferable to add the specific silicone oil to the first solvent containing the dispersed first conductive carbon particles after the dispersion treatment is performed on the first conductive carbon particles.

The first solvent is not particularly limited and may be appropriately determined depending on the type of resin used as the first resin, and the like. For example, in a case where the first resin is a polyimide resin or a polyamide-imide resin, for example, a polar solvent that will be described later is preferably used as the first solvent.

Examples of the polar solvent include N-methyl-2-pyrrolidone (NMP), N,N-dimethylformamide (DMF), N,N-dimethylacetamide (DMAc), N,N-diethylacetamide (DEAc), dimethyl sulfoxide (DMSO), hexamethylene phosphoramide (HEMPA), N-methylcaprolactam, N-acetyl-2-pyrrolidone, 1,3-dimethyl-imidazolidone (N,N-dimethylimidazolidione, DMI) and the like. Each of these solvents may be used alone, or two or more of these solvents may be used in combination.

In a case where the second coating liquid-preparing step is performed, in the second coating liquid-preparing step, the second coating liquid containing the second resin, the second conductive carbon particles, and the second solvent is prepared. The second resin and the second conductive carbon particles are as described above, and the method of preparing the second coating liquid and the second solvent are the same as the method of preparing the first coating liquid and the first solvent, respectively.

### Coating Film-Forming Step

In the first coating film-forming step, the first coating film is formed by coating the outer periphery of the material as a coating target with the first coating liquid.

Examples of the material as a coating target include a cylindrical or columnar mold, and the like. The material as a coating target may be the aforementioned mold with an outer peripheral surface treated with a release agent. In a case where the endless belt that is a single layer structure is to be manufactured, in the first coating film-forming step, for example, the material as a coating target or the outer peripheral surface of the material as a coating target treated with a release agent is directly coated with the first coating liquid. In a case where the endless belt that is a laminate is to be manufactured, in the first coating film-forming step, for example, the material as a coating target or the outer peripheral surface of the material as a coating target on which the second layer or the second coating film is formed is coated with the first coating liquid.

Examples of the method of coating with the first coating liquid include known methods such as a spray coating method, a spiral coating (flow coating) method, a blade coating method, a wire bar coating method, a dip coating method, a bead coating method, an air knife coating method, and a curtain coating method.

In a case where the second coating film-forming step is performed, in the second coating film-forming step, the second coating film is formed by coating the outer periphery of the material as a coating target with the second coating liquid. The method of coating with the second coating liquid is also the same as the method of coating with the first coating liquid.

### Drying Step

In the first drying step, the first coating film formed in the first coating film-forming step is dried. By the first drying step, the first solvent contained in the first coating film is removed, and a single layer or the first layer is obtained.

Examples of the method of drying the first coating film include a method of supplying hot air to the first coating film, a method of heating the material as a coating target, and the like.

In the first drying step, in a case where A° C. represents an integral average of the temperature of the material as a coating target in the drying step, and Bmin represents time taken for the temperature of the material as a coating target to reach the integral average A° C. after the beginning of drying, for example, an integral average heating rate A/B (° C./min) is preferably 5.74° C./min or more. In a case where the integral average heating rate A/B (° C./min) is 5.74° C./min or more, the first coating film dries quickly. Accordingly, the first conductive carbon particles in the first coating film are fixed before being aggregated, and the first conductive carbon particles in the obtained layer are in an excellent dispersion state. In addition, presumably, because the first conductive carbon particles are finely dispersed in the obtained layer, it is more likely that the L(r) integral value will fall into the range of 0 or more and 0.1 or less.

In order to calculate the integral average heating rate A/B, first, the temporal change of the temperature of the material as a coating target in the drying step is measured by connecting a thermometer (for example, a K thermocouple manufactured by GRAPHTEC Corporation., model number: JBS-7115-5M-K) to a data recorder (model number: GL240) manufactured by GRAPHTEC Corporation. Then, the temperature at a point in time when the integral value (area) of the temperature of the material as a coating target from the beginning of drying equals half of the integral value (area) of the temperature of the material as a coating target from the beginning of drying to the end of drying is defined as “integral average (A° C.)”, the time (Bmin) taken for the temperature of the material as a coating target to reach the integral average A° C. is determined, and the integral average heating rate A/B (° C./min) is calculated.

The integral average heating rate A/B (° C./min) is, for example, more preferably 5.74° C./min or more, and even more preferably 8.0° C./min or more.

The method of controlling the integral average heating rate A/B within the above range is not particularly limited. For instance, in a case where the first coating film is dried by supplying hot air to the surface of the first coating film, examples of the method include a method of adjusting the speed of hot air on the surface of the first coating film, a method of adjusting the temperature of the hot air, and the like.

The speed of hot air on the surface of the first coating film is, for example, in a range of 0.1 m/s or more and 50 m/s or less, preferably in a range of 1 m/s or more and 40 m/s or less, and more preferably in a range of 1 m/s or more and 20 m/s or less.

The speed of the hot air on the surface of the first coating film is measured as follows. Specifically, the probe of an anemometer (TM350, manufactured by Tasco) is installed on the surface of the coating film to measure the speed of the hot air.

The temperature of the hot air on the surface of the first coating film is, for example, in a range of 100° C. or higher and 280° C. or lower, preferably in a range of 100° C. or higher and 250° C. or lower, and more preferably in a range of 110° C. or higher and 235° C. or lower.

The temperature of the hot air on the surface of the first coating film is measured by connecting a thermometer (for example, a K thermocouple manufactured by GRAPHTEC Corporation., model number: JBS-7115-5M-K) to a data recorder (model number: GL240) manufactured by GRAPHTEC Corporation.

The method of supplying the hot air to the surface of the first coating film is not particularly limited, and examples thereof include a method of blowing hot air of a drying furnace toward the surface of the first coating film from a slit nozzle, a method of directly supplying hot air of a drying furnace to the first coating film, and the like. Among these, from the viewpoint of facilitating control of the speed of the hot air on the surface of the first coating film, for example, a method using a slit nozzle is preferable.

In a case where the second drying step is performed, in the second drying step, the second coating film formed in the second coating film-forming step is dried. The method of drying the second coating film is the same as the method of drying the first coating film. The second drying step may be finished before the first coating film-forming step is performed. Alternatively, the first coating film-forming step may be performed before the second drying step is finished, and the first drying step may also serve as a part of the second drying step.

### Baking Step

As described above, the manufacturing method of the endless belt may go through the first baking step. In the first baking step, the first coating film dried by the first drying step is baked by heating. For example, in a case where the first resin is a polyimide resin, the polyamic acid contained in the first coating film is imidized by the first baking step to obtain polyimide.

The heating temperature in the first baking step is, for example, in a range of 150° C. or higher and 450° C. or lower, and preferably in a range of 200° C. or higher and 430° C. or lower. The heating time in the first baking step is, for example, in a range of 20 minutes or more and 180 minutes or less, and preferably in a range of 60 minutes or more and 150 minutes or less.

In a case where the endless belt that is a laminate is to be manufactured, and the second layer is formed through the second coating liquid-preparing step, the second coating film-forming step, and the second drying step, a second baking step of baking the second coating film dried by the second drying step may be performed. The second baking step may also serve as the first baking step.

### Primary Transfer Device

The primary transfer device is a device a primary transfer roll made of a metal that applies an electric field to an intermediate transfer member by coming into contact with an inner peripheral surface of the intermediate transfer member, and performs primary transfer of a toner image formed on a surface of an image holder to the outer peripheral surface of the intermediate transfer member.

The primary transfer roll made of a metal is arranged to face the image holder across the intermediate transfer member as the endless belt. In the primary transfer device, by the primary transfer roll made of a metal, a voltage with polarity opposite to charging polarity of a toner is applied to the intermediate transfer member, such that primary transfer of a toner image to the outer peripheral surface of the intermediate transfer member is performed.

Examples of the primary transfer roll include a metal member such as iron, copper, brass, stainless steel (SUS), sulfur-modified ultra-high strength steel (SUM), aluminum, or nickel. The primary transfer roll may be a hollow metal roll or a solid metal roll.

The outer diameter of the primary transfer roll is, for example, in a range of 4 mm or more and 28 mm or less.

The circumferential width of the nip region where the intermediate transfer member is interposed between the primary transfer roll and the image holder is, for example, in a range of 0.5 mm or more and 5 mm or less.

### Secondary Transfer Device

The secondary transfer device is a device that performs secondary transfer of the toner image transferred to the outer peripheral surface of the intermediate transfer member to a surface of a recording medium.

The secondary transfer device includes, for example, a secondary transfer roll which is arranged on the outer peripheral surface side of the intermediate transfer member, that is, the side on which the toner image is held, and a back roll which is arranged on the inner peripheral surface side of the intermediate transfer member, that is, the side opposite to the side on which the toner image is held. In the secondary transfer device, the intermediate transfer member and the recording medium are interposed between the secondary transfer roll and the back roll to form a transfer electric field. In this way, secondary transfer of the toner image formed on the intermediate transfer member to the recording medium is performed.

### Image Forming Apparatus

The image forming apparatus according to the present exemplary embodiment includes an image holder, a charging device that charges a surface of the image holder, an electrostatic latent image forming device that forms an electrostatic latent image on the charged surface of the image holder, a developing device that contains a developer containing a toner and develops the electrostatic latent image formed on the surface of the image holder with the developer to form a toner image, and a transfer device that transfers the toner image to a surface of a recording medium, in which the aforementioned transfer device is used as the transfer device.

As the image forming apparatus according to the present exemplary embodiment, known image forming apparatuses are used which include an apparatus including a fixing means that fixes a toner image transferred to the surface of a recording medium; an apparatus including a cleaning means that cleans the surface of an image holder not yet being charged after transfer of a toner image; an apparatus including an electricity removing means that removes electricity by irradiating the surface of an image holder, the image holder not yet being charged, with electricity removing light after transfer of a toner image; an apparatus including an image holder heating member that raises the temperature of an image holder to reduce relative temperature, and the like.

In the image forming apparatus according to the present exemplary embodiment, for example, a portion including the image holder may be a cartridge structure (process cartridge) detachable from the image forming apparatus.

Hereinafter, an example of the image forming apparatus according to the present exemplary embodiment will be described with reference to drawings. Here, the image forming apparatus according to the present exemplary embodiment is not limited thereto. Hereinafter, among the parts shown in the drawing, main parts will be described, and others will not be described.

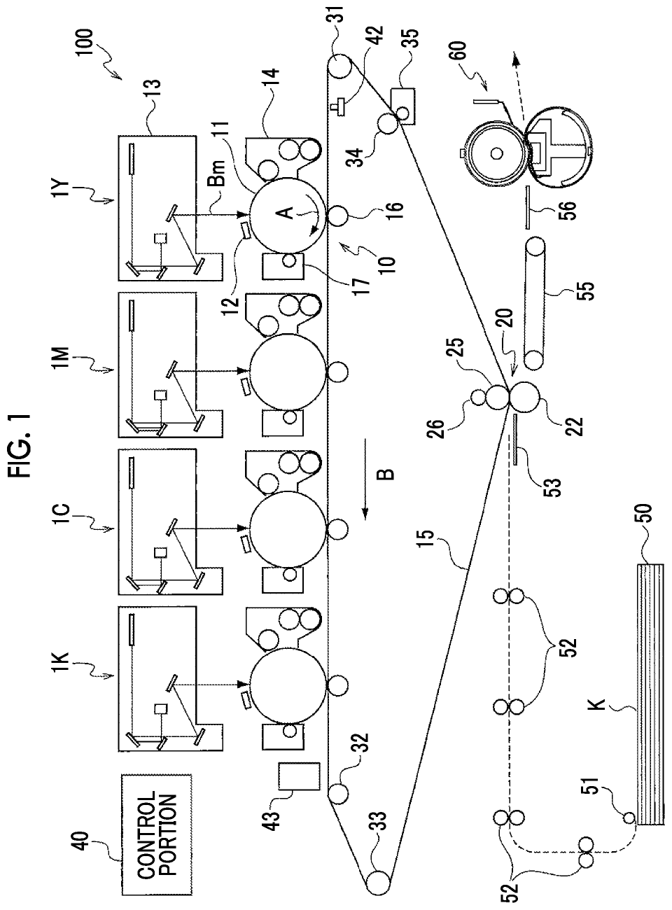

FIG. 1 is a schematic configuration view showing the configuration of the image forming apparatus according to the present exemplary embodiment.

As shown in FIG. 1, an image forming apparatus 100 according to the present exemplary embodiment is, for example, an intermediate transfer-type image forming apparatus that is generally called a tandem type, and includes a plurality of image forming units 1Y, 1M, 1C, and 1K in which a toner image of each color component is formed by an electrophotographic method, a primary transfer portion 10 (an example of a primary transfer device) that performs sequential transfer (primary transfer) of the toner image of each color component formed by each of the image forming units 1Y, 1M, 1C, and 1K to an intermediate transfer belt 15 (an example of an intermediate transfer member), a secondary transfer portion 20 (an example of a secondary transfer device) that performs batch transfer (secondary transfer) of the overlapped toner images transferred to the intermediate transfer belt 15 to paper K as a recording medium, and a fixing device 60 that fixes the images transferred by the secondary transfer on the paper K (an example of a recording medium). The image forming apparatus 100 also has a control portion 40 that controls the operation of each device (each portion).

Each of the image forming units 1Y, 1M, 1C, and 1K of the image forming apparatus 100 includes a photoreceptor 11 that rotates in the direction of an arrow A, as an example of an image holder that holds a toner image formed on the surface.

Around the photoreceptor 11, there are provided a charger 12 for charging the photoreceptor 11 as an example of a charging device and a laser exposure machine 13 for drawing an electrostatic latent image on the photoreceptor 11 as an example of an electrostatic latent image forming device (in FIG. 1, the exposure beam is represented by a mark Bm).

Around the photoreceptor 11, as an example of a developing device, there are provided a developing machine 14 that contains toners of each color component and makes the electrostatic latent image on the photoreceptor 11 into a visible image by using the toners and a primary transfer roll 16 made of a metal that transfers toner images of each color component formed on the photoreceptor 11 to the intermediate transfer belt 15 by the primary transfer portion 10.

Examples of the toner include a toner having a volume-average particle size of 2 μm or more and 5 μm or less. The volume-average particle size of the toner is, for example, more preferably in a range of 3.5 μm or more and 4.8 μm or less.

The volume-average particle size of the toner is measured using COULTER MULTISIZER II (manufactured by Beckman Coulter Inc.) and using ISOTON-II (manufactured by Beckman Coulter Inc.) as an electrolytic solution. For measurement, a measurement sample in an amount of 0.5 mg or more and 50 mg or less is added to 2 ml of a 5% aqueous solution of a surfactant (preferably sodium alkylbenzene sulfonate, for example) as a dispersant. The obtained solution is added to an electrolytic solution in a volume of 100 ml or more and 150 ml or less. The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000. For the particle size range (channel) divided based on the measured particle size distribution, a cumulative volume distribution is drawn from small-sized particles. The particle size at which the cumulative percentage of the particles reaches 50% is defined as a volume-average particle size.

Around the photoreceptor 11, there are provided a photoreceptor cleaner 17 that removes the residual toner on the photoreceptor 11 and devices for electrophotography, such as the charger 12, the laser exposure machine 13, the developing machine 14, the primary transfer roll 16, and the photoreceptor cleaner 17, that are arranged in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

By various rolls, the intermediate transfer belt 15 is driven to circulate (rotate) in a direction B shown in FIG. 1 at a speed fit for the purpose. The image forming apparatus 100 has, as the various rolls, a driving roll 31 that is driven by a motor (not shown in the drawing) excellent in maintaining a constant speed and rotates the intermediate transfer belt 15, a support roll 32 that supports the intermediate transfer belt 15 substantially linearly extending along the arrangement direction of the photoreceptors 11, a tension applying roll 33 that applies tension to the intermediate transfer belt 15 and functions as a correcting roll preventing meandering of the intermediate transfer belt 15, a back roll 25 that is provided in the secondary transfer portion 20, and a back roll 34 for cleaning that is provided in a cleaning portion scrapping off the residual toner on the intermediate transfer belt 15.

The primary transfer portion 10 is configured with the primary transfer roll 16 that is arranged to face the photoreceptor 11 across the intermediate transfer belt 15. The primary transfer roll 16 is arranged to be pressed on the photoreceptor 11 across the intermediate transfer belt 15, and the polarity of voltage (primary transfer bias) applied to the primary transfer roll 16 is opposite to the charging polarity (negative polarity, the same shall apply hereinafter) of the toner. As a result, the toner image on each photoreceptor 11 is sequentially electrostatically sucked onto the intermediate transfer belt 15, which leads to the formation of overlapped toner images on the intermediate transfer belt 15.

The secondary transfer portion 20 includes the back roll 25 and a secondary transfer roll 22 that is arranged on a toner image-holding surface side of the intermediate transfer belt 15.

The back roll 25 is formed such that the surface resistivity thereof is 1×10⁷Ω/□ or more and 1×10¹⁰Ω/□ or less. The hardness of the back roll 25 is set to, for example, 700 (ASKER C: manufactured by KOBUNSHI KEIKI CO., LTD., the same shall apply hereinafter). The back roll 25 is arranged on the back surface side of the intermediate transfer belt 15 to configure a counter electrode of the secondary transfer roll 22. A power supply roll 26 made of a metal to which secondary transfer bias is stably applied is arranged to come into contact with the back roll 25.

On the other hand, the secondary transfer roll 22 is a cylindrical roll having a volume resistivity of 10^{7.5} Ω-cm or more and 10^{8.5} Ωcm or less. The secondary transfer roll 22 is arranged to be pressed on the back roll 25 across the intermediate transfer belt 15. The secondary transfer roll 22 is grounded such that the secondary transfer bias is formed between the secondary transfer roll 22 and the back roll 25, which induces secondary transfer of the toner image onto the paper K transported to the secondary transfer portion 20.

The transport speed of the paper K in the secondary transfer portion 20 is, for example, in a range of 50 mm/s or more and 600 mm/s or less.

On the downstream side of the secondary transfer portion 20 of the intermediate transfer belt 15, an intermediate transfer belt cleaner 35 separable from the intermediate transfer belt 15 is provided which removes the residual toner or paper powder on the intermediate transfer belt 15 remaining after the secondary transfer and cleans the surface of the intermediate transfer belt 15.

The intermediate transfer belt 15, the primary transfer portion 10 (primary transfer roll 16), and the secondary transfer portion 20 (secondary transfer roll 22) correspond to an example of the transfer device.

The image forming apparatus 100 may have a configuration in which the apparatus includes a secondary transfer belt instead of the secondary transfer roll 22.

On the other hand, on the upstream side of the yellow image forming unit 1Y, a reference sensor (home position sensor) 42 is arranged which generates a reference signal to be a reference for taking the image forming timing in each of the image forming units 1Y, 1M, 1C, and 1K. On the downstream side of the black image forming unit 1K, an image density sensor 43 for adjusting image quality is arranged. The reference sensor 42 recognizes a mark provided on the back side of the intermediate transfer belt 15 and generates a reference signal. Each of the image forming units 1Y, 1M, 1C, and 1K is configured such that these units start to form images according to the instruction from the control portion 40 based on the recognition of the reference signal.

The image forming apparatus according to the present exemplary embodiment includes, as a transport means for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer portion 20, a transport belt 55 that transports the paper K transported after going through secondary transfer by the secondary transfer roll 22 to the fixing device 60, and a fixing entrance guide 56 that guides the paper K to the fixing device 60.

Next, the basic image forming process of the image forming apparatus according to the present exemplary embodiment will be described.

In the image forming apparatus according to the present exemplary embodiment, image data output from an image reading device not shown in the drawing, a personal computer (PC) not shown in the drawing, or the like is subjected to image processing by an image processing device not shown in the drawing, and then the image forming units 1Y, 1M, 1C, and 1K perform the image forming operation.

In the image processing device, image processing, such as shading correction, misregistration correction, brightness/color space conversion, gamma correction, or various image editing works such as frame erasing or color editing and movement editing, is performed on the input image data. The image data that has undergone the image processing is converted into color material gradation data of 4 colors, Y, M, C, and K, and is output to the laser exposure machine 13.

In the laser exposure machine 13, according to the input color material gradation data, for example, the photoreceptor 11 of each of the image forming units 1Y, 1M, 1C, and 1K is irradiated with the exposure beam Bm emitted from a semiconductor laser. The surface of each of the photoreceptors 11 of the image forming units 1Y, 1M, 1C, and 1K is charged by the charger 12 and then scanned and exposed by the laser exposure machine 13. In this way, an electrostatic latent image is formed. By each of the image forming units 1Y, 1M, 1C, and 1K, the formed electrostatic latent image is developed as a toner image of each of the colors Y, M, C, and K.

In the primary transfer portion 10 where each photoreceptor 11 and the intermediate transfer belt 15 come into contact with each other, the toner images formed on the photoreceptors 11 of the image forming units 1Y, 1M, 1C, and 1K are transferred onto the intermediate transfer belt 15. More specifically, in the primary transfer portion 10, by the primary transfer roll 16, a voltage (primary transfer bias) with a polarity opposite to the charging polarity (negative polarity) of the toner is applied to the substrate of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer portion 20. In a case where the toner images are transported to the secondary transfer portion 20, in the transport means, the paper feeding roll 51 rotates in accordance with the timing at which the toner images are transported to the secondary transfer portion 20, and the paper K having the target size is fed from the paper storage portion 50. The paper K fed from the paper feeding roll 51 is transported by the transport roll 52, passes through the transport guide 53, and reaches the secondary transfer portion 20. Before reaching the secondary transfer portion 20, the paper K is temporarily stopped, and a positioning roll (not shown in the drawing) rotates according to the movement timing of the intermediate transfer belt 15 holding the toner images, so that the position of the paper K is aligned with the position of the toner images.

In the secondary transfer portion 20, via the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer portion 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. Then, the paper K on which a fixed image is formed is transported to an ejected paper-storing portion (not shown in the drawing) provided in an ejection portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the back roll 34 for cleaning and an intermediate transfer belt cleaner 35.

Hitherto, the present exemplary embodiment has been described. However, the present exemplary embodiment is not limited to the above exemplary embodiments, and various modifications, changes, and ameliorations can be added thereto.

### EXAMPLES

Examples of the present invention will be described below, but the present invention is not limited to the following examples. In the following description, unless otherwise specified, “parts” and “%” are based on mass in all cases.

### Example A1

### Preparation of Coating Liquid A1

A mixture obtained by adding 39.6 g (22 phr) of oxidized gas black (channel black, manufactured by Orion Engineered Carbons S.A., FW200, number-average primary particle size: 13 nm) as first conductive carbon particles to 1,000 g of fully aromatic polyimide varnish (solid content: 18% by mass, manufactured by UNITIKA LTD., U-IMIDE KX, solvent: NMP) is passed through an φ0.1 mm orifice of a high-pressure collision disperser (manufactured by Genus) under a pressure of 200 MPa, and the slurry divided into two portions dispersed by are dispersed by being caused to collide with each other 20 times, thereby obtaining a dispersion. A polyether-modified silicone oil (6.8 g, dual end-type polyether-modified silicone oil, manufactured by Shin-Etsu Chemical Co., Ltd., trade name: KF-600x, number of carbon atoms contained in an organic group: 6, number-average molecular weight: 900, viscosity at 20° C.: 2 mPa·s) is added to the obtained dispersion, followed by stirring, thereby obtaining a coating liquid A1 as a first coating liquid.

### Preparation of Belt A1

By a flow coating method, the outer surface of a φ366 (outer diameter: 366 mm) SUS pipe is coated with the obtained coating liquid A1 such that a predetermined film thickness is obtained, and the pipe is rotated and dried at 150° C. for 30 minutes. Then, the pipe is placed in an oven at 320° C. for 4 hours and then taken out, thereby obtaining an SUS pipe having an endless belt A1 formed on the outer surface. The total film thickness of the endless belt A1 (that is, the film thickness of the single layer) is 80 μm. The integral average heating rate A/B in the drying step is 8.0° C./min.

The endless belt A1 that coats the outer surface of the SUS pipe is removed from the pipe, and cut in a width of 369 mm, thereby obtaining a belt A1 which is a belt-shaped intermediate transfer member. The content of the conductive carbon particles with respect to the entire belt A1 is 17.5% by mass, and the content of the silicone oil with respect to the entire belt A1 is 3% by mass.

Furthermore, as a result of measuring the volume resistivity of the belt A1 and the surface resistivity of the outer peripheral surface of the belt A1 by the method described above, the value of common logarithm of the volume resistivity is 9.8 (log Ω·cm), and the value of common logarithm of the surface resistivity is 9.6 (log Ω/suq.).

### Example A2

A coating liquid A2 is obtained in the same manner as the coating liquid A1, except that the amount of the oxidized gas black added as the first conductive carbon particles is changed to 32.9 g (18.3 phr) from 39.6 g.

A belt A2 is obtained in the same manner as the belt A1, except that the coating liquid A2 is used instead of the coating liquid A1.

The total film thickness (that is, the film thickness of the single layer) of the belt A2 is 80 μm, the content of the conductive carbon particles with respect to the entire belt A2 is 15.0% by mass, and the content of the silicone oil with respect to the entire belt A2 is 3% by mass.

Furthermore, as a result of measuring the volume resistivity of the belt A2 and the surface resistivity of the outer peripheral surface of the belt A2 by the method described above, the value of common logarithm of the volume resistivity is 11.0 (log Ω·cm), and the value of common logarithm of the surface resistivity is 10.8 (log Ω/suq.).

### Example A3

A coating liquid A3 is obtained in the same manner as the coating liquid A1, except that the amount of the polyether-modified silicone oil added is changed to 11.6 g from 6.8 g.

A belt A3 is obtained in the same manner as the belt A1, except that the coating liquid A3 is used instead of the coating liquid A1.

The total film thickness (that is, the film thickness of the single layer) of the belt A3 is 80 μm, the content of the conductive carbon particles with respect to the entire belt A3 is 17.1% by mass, and the content of the silicone oil with respect to the entire belt A3 is 5% by mass.

Furthermore, as a result of measuring the volume resistivity of the belt A3 and the surface resistivity of the outer peripheral surface of the belt A3 by the method described above, the value of common logarithm of the volume resistivity is 9.8 (log Ω·cm), and the value of common logarithm of the surface resistivity is 9.8 (log Ω/suq.).

### Example A4

A coating liquid A4 is obtained in the same manner as the coating liquid A1, except that the amount of the polyether-modified silicone oil added is changed to 16.6 g from 6.8 g.

A belt A4 is obtained in the same manner as the belt A1, except that the coating liquid A4 is used instead of the coating liquid A1.

The total film thickness (that is, the film thickness of the single layer) of the belt A4 is 80 μm, the content of the conductive carbon particles with respect to the entire belt A4 is 16.8% by mass, and the content of the silicone oil with respect to the entire belt A4 is 7% by mass.

Furthermore, as a result of measuring the volume resistivity of the belt A4 and the surface resistivity of the outer peripheral surface of the belt A4 by the method described above, the value of common logarithm of the volume resistivity is 9.8 (log Ω·cm), and the value of common logarithm of the surface resistivity is 9.5 (log Ω/suq.).

### Example A5

A coating liquid A5 is obtained in the same manner as the coating liquid A1, except that the amount of the polyether-modified silicone oil added is changed to 55 g from 6.8 g.

A belt A5 is obtained in the same manner as the belt A1, except that the coating liquid A5 is used instead of the coating liquid A1.

The total film thickness (that is, the film thickness of the single layer) of the belt A5 is 80 μm, the content of the conductive carbon particles with respect to the entire belt A5 is 14.4% by mass, and the content of the silicone oil with respect to the entire belt A5 is 20% by mass.

Furthermore, as a result of measuring the volume resistivity of the belt A5 and the surface resistivity of the outer peripheral surface of the belt A5 by the method described above, the value of common logarithm of the volume resistivity is 12.0 (log Ω·cm), and the value of common logarithm of the surface resistivity is 11.6 (log Ω/suq.).

### Example A6

A coating liquid A6 is obtained in the same manner as the coating liquid A1, except that the amount of the polyether-modified silicone oil added is changed to 2.3 g from 6.8 g.

A belt A6 is obtained in the same manner as the belt A1, except that the coating liquid A6 is used instead of the coating liquid A1.

The total film thickness (that is, the film thickness of the single layer) of the belt A6 is 80 μm, the content of the conductive carbon particles with respect to the entire belt A6 is 17.9% by mass, and the content of the silicone oil with respect to the entire belt A6 is 1% by mass.

Furthermore, as a result of measuring the volume resistivity of the belt A6 and the surface resistivity of the outer peripheral surface of the belt A6 by the method described above, the value of common logarithm of the volume resistivity is 10.0 (log Ω·cm), and the value of common logarithm of the surface resistivity is 11.2 (log Ω/suq.).

### Example A7

A coating liquid A7 is obtained in the same manner as the coating liquid A1, except that a long-chain alkyl-modified silicone oil (side chain-type long-chain alkyl-modified silicone oil, manufactured by Shin-Etsu Chemical Co., Ltd., trade name: KF-41x, number of carbon atoms contained in an organic group: 10, number-average molecular weight: 1,100, viscosity at 20° C.: 4 mPa·s) is used instead of the polyether-modified silicone oil.

A belt A7 is obtained in the same manner as the belt A1, except that the coating liquid A7 is used instead of the coating liquid A1.

The total film thickness (that is, the film thickness of the single layer) of the belt A7 is 80 μm, the content of the conductive carbon particles with respect to the entire belt A7 is 17.5% by mass, and the content of the silicone oil with respect to the entire belt A7 is 3% by mass.

Furthermore, as a result of measuring the volume resistivity of the belt A7 and the surface resistivity of the outer peripheral surface of the belt A7 by the method described above, the value of common logarithm of the volume resistivity is 9.8 (log Ω·cm), and the value of common logarithm of the surface resistivity is 9.6 (log Ω/suq.).

### Example A8

A coating liquid A8 is obtained in the same manner as the coating liquid A1, except that an epoxy-modified silicone oil (side-chain dual end-type epoxy-modified silicone oil, manufactured by Shin-Etsu Chemical Co., Ltd., trade name: X-22-900x, number of carbon atoms contained in an organic group: 9, number-average molecular weight: 1,100, viscosity at 20° C.: 4 mPa·s) is used instead of the polyether-modified silicone oil.

A belt A8 is obtained in the same manner as the belt A1, except that the coating liquid A8 is used instead of the coating liquid A1.

The total film thickness (that is, the film thickness of the single layer) of the belt A8 is 80 μm, the content of the conductive carbon particles with respect to the entire belt A8 is 17.5% by mass, and the content of the silicone oil with respect to the entire belt A8 is 3% by mass.

Furthermore, as a result of measuring the volume resistivity of the belt A8 and the surface resistivity of the outer peripheral surface of the belt A8 by the method described above, the value of common logarithm of the volume resistivity is 9.8 (log Ω·cm), and the value of common logarithm of the surface resistivity is 9.6 (log Ω/suq.).

### Example A9

A coating liquid A9 is obtained in the same manner as the coating liquid A1, except that a dimethyl silicone oil (dimethylpolysiloxane, manufactured by Kyoei Kagaku Kogyo, trade name: KL400, number-average molecular weight: 200, viscosity at 20° C.: 0.5 mPa·s) is used instead of the polyether-modified silicone oil.

A belt A9 is obtained in the same manner as the belt A1, except that the coating liquid A9 is used instead of the coating liquid A1.

The total film thickness (that is, the film thickness of the single layer) of the belt A9 is 80 μm, the content of the conductive carbon particles with respect to the entire belt A9 is 17.5% by mass, and the content of the silicone oil with respect to the entire belt A9 is 3% by mass.

Furthermore, as a result of measuring the volume resistivity of the belt A9 and the surface resistivity of the outer peripheral surface of the belt A9 by the method described above, the value of common logarithm of the volume resistivity is 9.8 (log Ω·cm), and the value of common logarithm of the surface resistivity is 11.0 (log Ω/suq.).

### Example A10

A coating liquid A10 is obtained in the same manner as the coating liquid A1, except that 43.2 g (24 phr) of oxidized gas black (channel black, manufactured by Orion Engineered Carbons S.A., SB6, number-average primary particle size: 17 nm) is used as the first conductive carbon particles.

A belt A10 is obtained in the same manner as the belt A1, except that the coating liquid A10 is used instead of the coating liquid A1.

The total film thickness (that is, the film thickness of the single layer) of the belt A10 is 80 μm, the content of the conductive carbon particles with respect to the entire belt A10 is 18.8% by mass, and the content of the silicone oil with respect to the entire belt A10 is 3% by mass.

Furthermore, as a result of measuring the volume resistivity of the belt A10 and the surface resistivity of the outer peripheral surface of the belt A10 by the method described above, the value of common logarithm of the volume resistivity is 9.5 (log Ω·cm), and the value of common logarithm of the surface resistivity is 9.5 (log Ω/suq.).

### Example B1

### Preparation of Coating Liquid B1

A mixture obtained by adding 37.8 g (22 phr) of oxidized gas black (channel black, manufactured by Orion Engineered Carbons S.A., FW200, number-average primary particle size: 13 nm) as first conductive carbon particles to 1,000 g of aromatic polyamide-imide varnish (solid content: 18% by mass, HPC-9000 manufactured by Resonac Holdings Corporation., solvent: NMP) is passed through an φ0.1 mm orifice of a high-pressure collision disperser (manufactured by Genus) under a pressure of 200 MPa, and the slurry divided into two portions are dispersed by being caused to collide with each other 10 times, thereby obtaining a dispersion. A polyether-modified silicone oil (6.8 g, dual end-type polyether-modified silicone oil, manufactured by Shin-Etsu Chemical Co., Ltd., trade name: KF-600x, number of carbon atoms contained in an organic group: 6, number-average molecular weight: 900, viscosity at 20° C.: 2 mPa·s) is added to the obtained dispersion, followed by stirring, thereby obtaining a coating liquid B1 as a first coating liquid.

### Preparation of Belt B1

Treating Material as Coating Target with Release Agent

As a material as a coating target, a cylindrical mold made of SUS material having an outer diameter of 366 mm and a length of 400 mm is prepared. The outer surface of the mold is coated with a silicone-based release agent (manufactured by Shin-Etsu Chemical Co., Ltd., trade name: SEPACOAT SP) and subjected to a drying treatment (treated with a release agent).

### Formation of First Coating Film

In a state where the cylindrical mold treated with a release agent is being rotated in the circumferential direction at a speed of 10 rpm, the coating liquid B1 is discharged thereto from a dispenser having a diameter of 1.0 mm such that the cylindrical mold is coated from the end portion, and a metal blade installed on the mold is pressed on the mold with a uniform pressure such that the mold is coated. The dispenser unit is moved in the axial direction of the cylindrical mold at a speed of 100 mm/min such that the coating liquid B1 is spirally applied to the cylindrical mold, thereby forming a first coating film.

### Drying of First Coating Film

Then, the mold and the first coating film are subjected to a drying treatment for 15 minutes by being rotated at 10 rpm in a drying furnace in an air atmosphere at 150° C. The integral average heating rate A/B of the first coating film in the drying step is 6.0° C./min.

### Baking

Next, the cylindrical mold is placed in an oven set to an end temperature of 290° C. for 4 hours, thereby obtaining an endless belt B1. The total film thickness of the endless belt B1 (that is, the film thickness of the single layer) is 80 μm.

The endless belt B1 is removed from the mold, the collected endless belt B1 is stretched on a holder and cut with a cutter whose insertion angle is adjusted, thereby obtaining an annular substance having φ366 mm and a width of 369.5 mm. The intermediate transfer belt prepared in this way is named belt B1.

The content of the conductive carbon particles with respect to the entire belt B1 is 16.8% by mass, and the content of the silicone oil with respect to the entire belt B1 is 3% by mass.

Furthermore, as a result of measuring the volume resistivity of the belt B1 and the surface resistivity of the outer peripheral surface of the belt B1 by the method described above, the value of common logarithm of the volume resistivity is 9.9 (log Ω·cm), and the value of common logarithm of the surface resistivity is 9.5 (log Ω/suq.).

### Example C1

### Preparation of Belt C1

PEEK resin (450G manufactured by Victrex plc) pellets and furnace black (first conductive carbon particles, manufactured by Orion Engineered Carbons S.A., FW171, number-average primary particle size: 11 nm) are put in a Henschel mixer (FM10C manufactured by NIPPON COKE & ENGINEERING. CO., LTD.) such that a ratio of PEEK resin:furnace black=180 g:27 g (15 phr) is achieved, followed by mixing. A polyether-modified silicone oil (6.6 g, dual end-type polyether-modified silicone oil, manufactured by Shin-Etsu Chemical Co., Ltd., trade name: KF-600x, number of carbon atoms contained in an organic group: 6, number-average molecular weight: 900, viscosity at 20° C.: 2 mPa·s) is added to the mixed composition, followed by stirring. The mixture to which silicone oil is added is melted and kneaded with a twin-screw extrusion melt kneader (L/D60 (manufactured by PARKER CORPORATION)), the obtained resultant is extruded in the form of strings from a φ5 (inner diameter of 5 mm) orifice, the extruded resultant cooled and solidified by being put in a water tank and then cut, thereby obtaining mixed resin pellets mixed with furnace black.

The obtained mixed resin pellets are put in a single-screw melt extruder (L/D24, melt extruder (manufactured by MITSUBA MFG. CO., LTD.)) set to a predetermined temperature (380° C.), and extruded in a cylindrical shape from a gap between an annular die and a nipple while being melted. In order to fix the cylindrical shape and diameter of the film while pulling and collecting the extruded cylindrical film, the film is cooled in a state where the inner peripheral surface of the cylindrical film is brought into contact with a sizing die (cooling mold) set to a predetermined temperature (50° C.), thereby obtaining an endless belt C1.

The endless belt C1 is removed from the cooling mold, the collected endless belt C1 is stretched on a holder and cut with a cutter whose insertion angle is adjusted, thereby obtaining an annular substance having φ366 mm and a width of 369 mm. The intermediate transfer belt prepared in this way is named belt C1. The total film thickness of the belt C1 (that is, the film thickness of the single layer) is 80 μm.

The content of the conductive carbon particles with respect to the belt C1 is 12.6% by mass, and the content of the silicone oil with respect to the entire belt C1 is 3% by mass.

Furthermore, as a result of measuring the volume resistivity of the belt C1 and the surface resistivity of the outer peripheral surface of the belt C1 by the method described above, the value of common logarithm of the volume resistivity is 11.1 (log Ω·cm), and the value of common logarithm of the surface resistivity is 10.5 (log Ω/suq.).

### Example D1

### Preparation of Belt D1

PPS resin (Torelina T 1881 manufactured by TORAY INDUSTRIES, INC.) powder and gas black (first conductive carbon particles, channel black, manufactured by Orion Engineered Carbons S.A., FW1, number-average primary particle size: 13 nm) are put in a Henschel mixer (FM10C manufactured by NIPPON COKE & ENGINEERING. CO., LTD.) such that a ratio of PPS resin:gas black (that is, channel black)=180 g:27 g (15 phr) is achieved, followed by mixing. A polyether-modified silicone oil (6.6 g, dual end-type polyether-modified silicone oil, manufactured by Shin-Etsu Chemical Co., Ltd., trade name: KF-600x, number of carbon atoms contained in an organic group: 6, number-average molecular weight: 900, viscosity at 20° C.: 2 mPa·s) is added to the mixed composition, followed by stirring. The mixture to which silicone oil is added is melted and kneaded with a twin-screw extrusion melt kneader (L/D60 (manufactured by PARKER CORPORATION)), the obtained resultant is extruded in the form of strings from a φ5 (inner diameter of 5 mm) orifice, the extruded resultant cooled and solidified by being put in a water tank and then cut, thereby obtaining mixed resin pellets mixed with gas black (that is, channel black).

The obtained mixed resin pellets are put in a single-screw melt extruder (L/D24, melt extruder (manufactured by MITSUBA MFG. CO., LTD.)) set to a predetermined temperature (350° C.), and extruded in a cylindrical shape from a gap between an annular die and a nipple while being melted. In order to fix the cylindrical shape and diameter of the film while pulling and collecting the extruded cylindrical film, the film is cooled in a state where the inner peripheral surface of the cylindrical film is brought into contact with a sizing die (cooling mold) set to a predetermined temperature (50° C.), thereby obtaining an endless belt D1.

The endless belt D1 is removed from the cooling mold, the collected endless belt D1 is stretched on a holder and cut with a cutter whose insertion angle is adjusted, thereby obtaining an annular substance having φ366 mm and a width of 369 mm. The intermediate transfer belt prepared in this way is named belt D1. The total film thickness of the belt D1 (that is, the film thickness of the single layer) is 80 μm.

The content of the conductive carbon particles with respect to the belt D1 is 12.6% by mass, and the content of the silicone oil with respect to the entire belt D1 is 3% by mass.

Furthermore, as a result of measuring the volume resistivity of the belt D1 and the surface resistivity of the outer peripheral surface of the belt D1 by the method described above, the value of common logarithm of the volume resistivity is 11.1 (log Ω·cm), and the value of common logarithm of the surface resistivity is 10.5 (log Ω/suq.).

### Example E1

### Preparation of Belt E1

PEI resin (manufactured by SABIC, trade name: ULTEM) powder and gas black (first conductive carbon particles, channel black, manufactured by Orion Engineered Carbons S.A., FW1, number-average primary particle size: 13 nm) are put in a Henschel mixer (FM10C manufactured by NIPPON COKE & ENGINEERING. CO., LTD.) such that a ratio of PPS resin:gas black (that is, channel black)=180 g:27 g (15 phr) is achieved, followed by mixing. A polyether-modified silicone oil (6.6 g, dual end-type polyether-modified silicone oil, manufactured by Shin-Etsu Chemical Co., Ltd., trade name: KF-600x, number of carbon atoms contained in an organic group: 6, number-average molecular weight: 900, viscosity at 20° C.: 2 mPa·s) is added to the mixed composition, followed by stirring. The mixture to which silicone oil is added is melted and kneaded with a twin-screw extrusion melt kneader (L/D60 (manufactured by PARKER CORPORATION)), the obtained resultant is extruded in the form of strings from a φ5 (inner diameter of 5 mm) orifice, the extruded resultant cooled and solidified by being put in a water tank and then cut, thereby obtaining mixed resin pellets mixed with gas black (that is, channel black).

The obtained mixed resin pellets are put in a single-screw melt extruder (L/D24, melt extruder (manufactured by MITSUBA MFG. CO., LTD.)) set to a predetermined temperature (350° C.), and extruded in a cylindrical shape from a gap between an annular die and a nipple while being melted. In order to fix the cylindrical shape and diameter of the film while pulling and collecting the extruded cylindrical film, the film is cooled in a state where the inner peripheral surface of the cylindrical film is brought into contact with a sizing die (cooling mold) set to a predetermined temperature (50° C.), thereby obtaining an endless belt E1.

The endless belt E1 is removed from the cooling mold, the collected endless belt E1 is stretched on a holder and cut with a cutter whose insertion angle is adjusted, thereby obtaining an annular substance having φ366 mm and a width of 369 mm. The intermediate transfer belt prepared in this way is named belt E1. The total film thickness of the belt E1 (that is, the film thickness of the single layer) is 80 μm.

The content of the conductive carbon particles with respect to the belt E1 is 12.6% by mass, and the content of the silicone oil with respect to the entire belt E1 is 3% by mass.

Furthermore, as a result of measuring the volume resistivity of the belt E1 and the surface resistivity of the outer peripheral surface of the belt E1 by the method described above, the value of common logarithm of the volume resistivity is 11.1 (log Ω·cm), and the value of common logarithm of the surface resistivity is 10.0 (log Ω/suq.).

### Example F1

### Synthesis of Polyamic Acid

A polyamic acid DA-A1 which is a polyamic acid having an amino group on both ends of the molecular chain and a polyamic acid DC-A1 which is a polyamic acid having a carboxy group on both ends of the molecular chain are synthesized by the following method.

### Preparation of Polyamic Acid Solution DA-A1

As a diamine compound, 83.48 g (416.9 mmol) of 4,4′-diaminodiphenyl ether (hereinafter, abbreviated to “ODA”) is added to 800 g of N-methyl-2-pyrrolidone (hereinafter, abbreviated to “NMP”) and dissolved while being stirred at room temperature (25° C.).

Next, as tetracarboxylic dianhydride, 116.52 g (396.0 mmol) of 3,3′,4,4′-biphenyltetracarboxylic dianhydride (hereinafter abbreviated to “BPDA”) is slowly added thereto. After the addition and dissolution of the tetracarboxylic dianhydride, the temperature of the reaction solution is raised to 60° C., and then a polymerization reaction is carried out for 20 hours in a state where the reaction temperature is maintained, thereby obtaining a reaction solution containing the polyamic acid DA-A1 and NMP.

The obtained reaction solution is filtered using a #800 stainless steel mesh and cooled to room temperature (25° C.), thereby obtaining a polyamic acid solution DA-A1 having a solution viscosity of 2.0 Pa·s at 25° C.

The solution viscosity of the polyamic acid solution is a value measured using an E-type rotary viscometer TV-20H manufactured by TOKISANGYO with a standard rotor (1°34″×R24) under the conditions of measurement temperature: 25° C. and rotation speed: 0.5 rpm (100 Pa·s or more) and 1 rpm (less than 100 Pa·s).

The solution viscosity of the polyamic acid solution obtained in the following synthesis example is also a value measured in the same manner.

### Preparation of Polyamic Acid Solution DC-A1

A polyamic acid solution DC-A1 containing the polyamic acid DC-A1 and NMP and having a solution viscosity of 6.0 Pa·s is obtained in the same manner as in Synthesis Example 1, except that the amount of ODA is changed to 79.57 g (397.4 mmol) and the amount of BPDA is changed to 120.43 g (409.3 mmol).

### Preparation of Coating Liquid

### Preparation of Coating Liquid F2 (Second Coating Liquid)

Polyamic acid solution DA-A1 (concentration of solid content: 45% by mass) 70 parts by mass
Polyamic acid solution DC-A1 (concentration of solid content: 15% by mass) 30 parts by mass
Acidic carbon black (dry; conductive carbon particles)
[SPECIAL BLACK 4: manufactured by Orion Engineered Carbons S.A., pH 4.5, volatile fraction: 18.0%, gas black (that is, channel black), number-average primary particle size: 25 nm (hereinafter, abbreviated to “SB-4”)] 26 parts by mass

The polyamic acid solution DA-A1 and the polyamic acid solution DC-A1 having the above compositions are mixed together, SB-4 is added thereto, and the mixture is subjected to a dispersion treatment using a ball mill at 30° C. for 12 hours such that the mixed solution of the polyamic acid solutions is dispersed. Then, the mixed solution containing dispersed SB-4 is filtered through a #400 stainless steel mesh, thereby obtaining a coating liquid F2 as a second coating liquid.

### Preparation of Coating Liquid F1 (First Coating Liquid)

Polyamic acid solution DA-A1 (concentration of solid content: 45% by mass) 70 parts by mass
Polyamic acid solution DC-A1 (concentration of solid content: 15% by mass) 30 parts by mass
Acidic carbon black (dry; conductive carbon particles)
[Color Black FW200, manufactured by Orion Engineered Carbons S.A., gas black (that is, channel black), number-average primary particle size: 13 nm, pH: 3.0 (hereinafter abbreviated to “FW200”)] 18 parts by mass
Polyether-modified silicone oil (6.6 g, dual end-type polyether-modified silicone oil, manufactured by Shin-Etsu Chemical Co., Ltd., trade name: KF-600x, number of carbon atoms contained in an organic group: 6, number-average molecular weight: 900, viscosity at 20° C.: 2 mPa·s) 6.8 parts by mass

The polyamic acid solution DA-A1 and the polyamic acid solution DC-A1 having the above compositions are mixed together, FW200 is added thereto, and the mixture is subjected to a dispersion treatment using a ball mill at 30° C. for 12 hours such that the mixed solution of the polyamic acid solutions is dispersed, thereby obtaining a dispersion. A polyether-modified silicone oil is added to the obtained dispersion and stirred for 10 minutes, thereby obtaining a mixed solution. Then, the mixed solution to which the silicone oil is added is filtered through a #800 stainless steel mesh, thereby obtaining a coating liquid F1 as a first coating liquid.

### Preparation of Belt F1

Treating Material as Coating Target with Release Agent

As a material as a coating target, a cylindrical mold made of SUS material having an outer diameter of 366 mm and a length of 400 mm is prepared. The outer surface of the mold is coated with a silicone-based release agent (manufactured by Shin-Etsu Chemical Co., Ltd., trade name: SEPACOAT SP) and subjected to a drying treatment (treated with a release agent).

### Formation of Second Coating Film

In a state where the cylindrical mold treated with a release agent is being rotated in the circumferential direction at a speed of 10 rpm, the coating liquid F2 is discharged thereto from a dispenser having a diameter of 1.0 mm such that the cylindrical mold is coated from the end portion, and a metal blade installed on the mold is pressed on the mold with a uniform pressure such that the mold is coated. The dispenser unit is moved in the axial direction of the cylindrical mold at a speed of 100 mm/min such that the coating liquid F2 is spirally applied to the cylindrical mold, thereby forming a second coating film.

### Drying of Second Coating Film

Then, the mold and the second coating film are subjected to a drying treatment for 15 minutes by being rotated at 10 rpm in a drying furnace in an air atmosphere at 140° C.

The solvent volatilizes from the second coating film after drying, which changes the second coating film to a polyamic acid resin-molded product (substrate 1) having self-supporting properties.

### Formation and Drying of First Coating Film

By the same rotation coating method as in the coating with the coating liquid F2, the outer peripheral surface of the substrate 1 is coated with the coating liquid F1 to form the first coating film, and then the first coating film is subjected to a drying treatment for 15 minutes while being rotated in a drying furnace at 10 rpm in an air atmosphere at 140° C. The integral average heating rate A/B of the first coating film in the drying step is 6.00° C./min.

### Baking

Next, the cylindrical mold is placed in an oven set to an end temperature of 320° C. for 4 hours, thereby obtaining an endless belt F1. The total film thickness of the endless belt F1 (total film thickness of the substrate layer and the surface layer) is 80 μm. The film thickness of the substrate layer is 26.7 μm, and the film thickness of the surface layer is 53.3 μm.

The endless belt F1 is removed from the mold, the collected endless belt F1 is stretched on a holder and cut with a cutter whose insertion angle is adjusted, thereby obtaining an annular substance having φ366 mm and a width of 369 mm. The intermediate transfer belt prepared in this way is named belt F1.

In the belt F1, the content of the conductive carbon particles with respect to the entire substrate layer is 22% by mass, the content of the conductive carbon particles with respect to the entire surface layer is 29% by mass, and the content of the silicone oil with respect to the entire surface layer is 3% by mass.

Furthermore, as a result of measuring the volume resistivity of the belt F1 and the surface resistivity of the outer peripheral surface of the belt F1 by the method described above, the value of common logarithm of the volume resistivity is 11.0 (log Ω·cm), and the value of common logarithm of the surface resistivity is 9.5 (log Ω/suq.).

### Comparative Example G1

The intermediate transfer belt of DocuCentre C2000 (manufactured by FUJIFILM Business Innovation Corp.) is used as it is as a belt G1.

The total film thickness (that is, the film thickness of the single layer) of the belt G1 is 75 μm, and the content of the conductive carbon particles with respect to the entire belt G1 is 13% by mass. The belt G1 does not contain a silicone oil.

Furthermore, as a result of measuring the volume resistivity of the belt G1 and the surface resistivity of the outer peripheral surface of the belt G1 by the method described above, the value of common logarithm of the volume resistivity is 10.0 (log Ω·cm), and the value of common logarithm of the surface resistivity is 9.8 (log Ω/suq.).

### Comparative Example G2

The intermediate transfer belt of Apeos C8180 (manufactured by FUJIFILM Business Innovation Corp.) is cut in a desired size (that is, in a width of 369 mm) and used as a belt G2.

The total film thickness (that is, the film thickness of the single layer) of the belt G2 is 80 μm, and the content of the conductive carbon particles with respect to the entire belt G2 is 16% by mass. The belt G2 does not contain a silicone oil.

Furthermore, as a result of measuring the volume resistivity of the belt G2 and the surface resistivity of the outer peripheral surface of the belt G2 by the method described above, the value of common logarithm of the volume resistivity is 11.0 (log Ω·cm), and the value of common logarithm of the surface resistivity is 10.8 (log Ω/suq.).

### Comparative Example G3

A coating liquid G3 is obtained in the same manner as the coating liquid A1, except that 16% by mass of oxidized gas black (manufactured by Degussa GmbH, Special Black SB4, number-average primary particle size: 25 nm) is used as the first conductive carbon particles.

A belt G3 is obtained in the same manner as the belt A1, except that the coating liquid G3 is used instead of the coating liquid A1.

The total film thickness (that is, the film thickness of the single layer) of the belt G3 is 80 μm, the content of the conductive carbon particles with respect to the entire belt G3 is 16% by mass, and the content of the silicone oil with respect to the entire belt G3 is 3% by mass.

Furthermore, as a result of measuring the volume resistivity of the belt G3 and the surface resistivity of the outer peripheral surface of the belt G3 by the method described above, the value of common logarithm of the volume resistivity is 10.5 (log Ω·cm), and the value of common logarithm of the surface resistivity is 9.5 (log Ω/suq.).

### Comparative Example G4

A coating liquid G4 is obtained in the same manner as the coating liquid A1, except that a fluorine-modified silicone oil (manufactured by Shin-Etsu Chemical Co., Ltd., trade name: KF400) is used instead of the polyether-modified silicone oil.

A belt G4 is obtained in the same manner as the belt A1, except that the coating liquid G4 is used instead of the coating liquid A1.

The total film thickness (that is, the film thickness of the single layer) of the belt G4 is 80 μm, the content of the conductive carbon particles with respect to the entire belt G4 is 17.5% by mass, and the content of the silicone oil with respect to the entire belt G4 is 3% by mass.

Furthermore, as a result of measuring the volume resistivity of the belt G4 and the surface resistivity of the outer peripheral surface of the belt G4 by the method described above, the value of common logarithm of the volume resistivity is 9.8 (log Ω·cm), and the value of common logarithm of the surface resistivity is 9.6 (log Ω/suq.).

### Comparative Example G5

A coating liquid G5 is obtained in the same manner as the coating liquid A1, except that a surfactant (an oligomer having a silicone structure having a methyl group, siloxane repetition number: 500, manufactured by Shin-Etsu Chemical Co., Ltd., trade name: KP126) is used instead of the polyether-modified silicone oil.

A belt G5 is obtained in the same manner as the belt A1, except that the coating liquid G5 is used instead of the coating liquid A1.

The total film thickness (that is, the film thickness of the single layer) of the belt G5 is 80 μm, the content of the conductive carbon particles with respect to the entire belt G5 is 17.5% by mass, and the content of the surfactant with respect to the entire belt G5 is 3% by mass. The belt G5 does not contain the specific silicone oil.

Furthermore, as a result of measuring the volume resistivity of the belt G5 and the surface resistivity of the outer peripheral surface of the belt G5 by the method described above, the value of common logarithm of the volume resistivity is 9.8 (log Ω·cm), and the value of common logarithm of the surface resistivity is 9.6 (log Ω/suq.).

### Endless Belt Measurement

For each of the obtained endless belts, the L(r) integral value is determined by the method described above. The results are shown in Table 1.

Table 1 also shows the layer configuration of the endless belt and the type of resin contained in the single layer or the first layer.

### Manufacturing of Transfer Device and Image Forming Apparatus

As the primary transfer roll made of a metal, a metal roll consisting of SUS304 having φ12 (outer diameter of 12 mm) and an axial length of 334 mm is used.

The obtained belt and the aforementioned primary transfer roll are mounted on Apeos C2360 (FUJIFILM Business Innovation Corp.), thereby obtaining an image forming apparatus including a transfer device.

The circumferential width of the nip region where the in which the intermediate transfer member is interposed between the primary transfer roll and the image holder is 4 mm.

### Evaluation

With the obtained image forming apparatus using a toner having a volume-average particle size of 5.8 μm, in an ambient environment of 10° C. and 15 RH %, an image on which a grid tilting at 45° and having 50 mm sides is superposed is printed on 2,000 sheets of A3 size coated paper in a full color mode at a full-surface halftone density of process black of 20%, in a full speed mode (transport speed: 308 mm/s) and a half speed mode (transport speed: 154 mm/s). The change in the image density outside the grid is defined as a ghost.

The second image (initial image) is observed to check whether or not the ghost occurs, and the suppression of the initial ghost phenomenon is evaluated based on the following standard.

In addition, the 2,000th image (image after continuous use) is observed to check whether or not the ghost occurs, and the suppression of the ghost phenomenon is evaluated based on the following standard.

### Standard

A: No ghost occurs in both the full speed mode and half speed mode.
B: No ghost occurs in the full speed mode.
C: Ghost occurs in both the full speed mode and half speed mode.

TABLE 1

| | | | Silicone oil | | | | |
|---|---|---|---|---|---|---|---|
| | | | | Content | L(r) | | |
| | Layer | Resin | | (% by | integral | Evaluation (ghost) | |
| | configuration | Type | Type | mass) | value | Initial | Sustainability |
| Example A1 | Single layer | PI | Polyether-modified | 3 | 0.03 | B | B |
| | structure | | | | | | |
| Example A2 | Single layer | PI | Polyether-modified | 3 | 0.01 | A | A |
| | structure | | | | | | |
| Example A3 | Single layer | PI | Polyether-modified | 5 | 0.03 | A | B |
| | structure | | | | | | |
| Example A4 | Single layer | PI | Polyether-modified | 7 | 0.04 | A | B |
| | structure | | | | | | |
| Example A5 | Single layer | PI | Polyether-modified | 20 | 0.07 | A | B |
| | structure | | | | | | |
| Example A6 | Single layer | PI | Polyether-modified | 1 | 0.01 | A | B |
| | structure | | | | | | |
| Example A7 | Single layer | PI | Long-chain alkyl- | 3 | 0.03 | A | A |
| | structure | | modified | | | | |
| Example A8 | Single layer | PI | Epoxy-modified | 3 | 0.02 | A | B |
| | structure | | | | | | |
| Example A9 | Single layer | PI | Dimethylpolysiloxane | 3 | 0.03 | B | B |
| | structure | | | | | | |
| Example A10 | Single layer | PI | Polyether-modified | 3 | 0.09 | B | B |
| | structure | | | | | | |
| Example B1 | Single layer | PAI | Polyether-modified | 3 | 0.09 | A | A |
| | structure | | | | | | |
| Example C1 | Single layer | PEEK | Polyether-modified | 3 | 0.10 | B | B |
| | structure | | | | | | |
| Example D1 | Single layer | PPS | Polyether-modified | 3 | 0.10 | B | B |
| | structure | | | | | | |
| Example E1 | Single layer | PEI | Polyether-modified | 3 | 0.10 | A | A |
| | structure | | | | | | |
| Example F1 | Laminate | PI | Polyether-modified | 3 | 0.03 | A | B |
| Comparative | Single layer | PI | N/A | 0 | 0.30 | C | C |
| Example G1 | structure | | | | | | |
| Comparative | Single layer | PI | N/A | 0 | 0.03 | C | C |
| Example G2 | structure | | | | | | |
| Comparative | Single layer | PI | Polyether-modified | 3 | 0.30 | C | C |
| Example G3 | structure | | | | | | |
| Comparative | Single layer | PI | Fluorine-modified | 3 | 0.20 | B | C |
| Example G4 | structure | | | | | | |
| Comparative | Single layer | PI | N/A | 0 | 0.03 | B | C |
| Example G5 | structure | | | | | | |

The results in Table 1 tell that compared to the transfer devices of comparative examples, the transfer devices of the present examples further suppress the ghost phenomenon even though a primary transfer roll made of a metal is used.

The present disclosure includes the following aspects.

(((1)))

A transfer device comprising:
an intermediate transfer member consisting of an endless belt which consists of a layer containing a resin including at least one resin selected from the group consisting of a polyimide resin, a polyamide-imide resin, an aromatic polyether ether ketone resin, a polyphenylene sulfide resin, and a polyetherimide resin, conductive carbon particles, a silicone oil containing at least one polymer selected from the group consisting of dimethylpolysiloxane and organic group-substituted dimethylpolysiloxane or has the layer as an outermost layer, and in which an integral value of a statistical quantity L(r) represented by the following Equation (1) is 0 or more and 0.1 or less at an interparticle distance r of 0.05 μm or more and 0.30 μm or less in a spatial distribution of the conductive carbon particles existing in a 6.3 μm×4.2 μm evaluation region within an outer peripheral surface of the endless belt;
a primary transfer device having a primary transfer roll made of a metal that applies an electric field to the intermediate transfer member by coming into contact with an inner peripheral surface of the intermediate transfer member, and performing primary transfer of a toner image formed on a surface of an image holder to the outer peripheral surface of the intermediate transfer member, and
a secondary transfer device performing secondary transfer of the toner image transferred to the outer peripheral surface of the intermediate transfer member to a surface of a recording medium.

$$L ( r ) := \sqrt{K ( r ) / π} - r \qquad ( 1 )$$

[In Equation (1), r represents the interparticle distance, and K(r) represents the Ripley's K function K(r) represented by the following Equation (2).]

$$K ( r ) := \frac{{\sum }_{i \neq j}^{N} 1 ( \vert {X}_{i} - {X}_{j} \vert \leq r ) / s ( \vert {X}_{i} - {X}_{j} \vert )}{{λ}^{2}} \qquad ( 2 )$$

[In Equation (2), 1(|Xᵢ−Xⱼ|≤r) represents an indicator function, Xᵢ and Xⱼ represent coordinates of points i and j respectively, |Xᵢ−Xⱼ| represents a Euclidean distance between the coordinates Xᵢ and Xⱼ, r represents the interparticle distance, s(|Xᵢ−Xⱼ|) represents an edge correction factor s(x) of an evaluation region represented by the following Equation (3), x equals |Xᵢ−Xⱼ|, N represents the total number of particles in the evaluation region, and X represents a number density of particles in the evaluation region.]

$$s ( x ) := {L}_{x} {L}_{y} - \frac{x}{π} ( 2 {L}_{x} + 2 {L}_{y} - x ) \qquad ( 3 )$$

[In Equation (3), Lₓ and L_{y} represent lengths (μm) of the sides of the evaluation region in an x-axis direction and a y-axis direction respectively, x equals |Xᵢ−Xⱼ|, Xᵢ and Xⱼ represent coordinates of points i and j respectively, and |Xᵢ−Xⱼ| represents a Euclidean distance between the coordinates Xᵢ and Xⱼ.]

(((2)))

The transfer device according to (((1))),
wherein the silicone oil contains a polyether-modified alkyl silicone oil as the organic group-substituted dimethylpolysiloxane.
   (((3)))

The transfer device according to (((1))) or (((2))),
wherein a content of the silicone oil is 1% by mass or more and 7% by mass or less with respect to the entire layer.
   (((4)))

The transfer device according to (((3))),
wherein the content of the silicone oil is 3% by mass or more and 5% by mass or less with respect to the entire layer.
   (((5)))

The transfer device according to any one of (((1))) to (((4))),
wherein the resin contains an imide-based resin.
   (((6)))

The transfer device according to (((5))),
wherein the imide-based resin contains a polyimide resin.
   (((7)))

The transfer device according to (((1))),
wherein the silicone oil contains a polyether-modified alkyl silicone oil as the organic group-substituted dimethylpolysiloxane, and
the resin contains an imide-based resin.
   (((8)))

The transfer device according to (((7))),
wherein the imide-based resin contains a polyimide resin.
   (((9)))

An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to any one of (((1))) to (((8))) that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer device comprising:
an intermediate transfer member consisting of an endless belt which consists of a layer containing a resin including at least one resin selected from the group consisting of a polyimide resin, a polyamide-imide resin, an aromatic polyether ether ketone resin, a polyphenylene sulfide resin, and a polyetherimide resin, conductive carbon particles, a silicone oil containing at least one polymer selected from the group consisting of dimethylpolysiloxane and organic group-substituted dimethylpolysiloxane or has the layer as an outermost layer, and in which an integral value of a statistical quantity L(r) represented by the following Equation (1) is 0 or more and 0.1 or less at an interparticle distance r of 0.05 μm or more and 0.30 μm or less in a spatial distribution of the conductive carbon particles existing in a 6.3 μm×4.2 μm evaluation region within an outer peripheral surface of the endless belt;
a primary transfer device having a primary transfer roll made of a metal that applies an electric field to the intermediate transfer member by coming into contact with an inner peripheral surface of the intermediate transfer member, and performing primary transfer of a toner image formed on a surface of an image holder to the outer peripheral surface of the intermediate transfer member; and
a secondary transfer device performing secondary transfer of the toner image transferred to the outer peripheral surface of the intermediate transfer member to a surface of a recording medium,
$$L ( r ) := \sqrt{K ( r ) / π} - r \qquad ( 1 )$$
[In Equation (1), r represents the interparticle distance, and K(r) represents the Ripley's K function K(r) represented by the following Equation (2)]
$$K ( r ) := \frac{{\sum }_{i \neq j}^{N} 1 ( \vert {X}_{i} - {X}_{j} \vert \leq r ) / s ( \vert {X}_{i} - {X}_{j} \vert )}{{λ}^{2}} \qquad ( 2 )$$
[in Equation (2), 1(|Xᵢ−Xⱼ|≤r) represents an indicator function, Xᵢ and Xⱼ represent coordinates of points i and j respectively, |Xᵢ−Xⱼ| represents a Euclidean distance between the coordinates Xᵢ and Xⱼ, r represents the interparticle distance, s(|Xᵢ−Xⱼ|) represents an edge correction factor s(x) of an evaluation region represented by the following Equation (3), x equals |Xᵢ−Xⱼ|, N represents the total number of particles in the evaluation region, and X represents a number density of particles in the evaluation region]
$$s ( x ) := {L}_{x} {L}_{y} - \frac{x}{π} ( 2 {L}_{x} + 2 {L}_{y} - x ) \qquad ( 3 )$$
[in Equation (3), Lₓ and L_{y} represent lengths (μm) of the sides of the evaluation region in an x-axis direction and a y-axis direction respectively, x equals |Xᵢ−Xⱼ|, Xᵢ and Xⱼ represent coordinates of points i and j respectively, and |Xᵢ−Xⱼ| represents a Euclidean distance between the coordinates Xᵢ and Xⱼ].

2. The transfer device according to claim 1,
wherein the silicone oil contains a polyether-modified alkyl silicone oil as the organic group-substituted dimethylpolysiloxane.

3. The transfer device according to claim 1,
wherein a content of the silicone oil is 1% by mass or more and 7% by mass or less with respect to the entire layer.

4. The transfer device according to claim 3,
wherein the content of the silicone oil is 3% by mass or more and 5% by mass or less with respect to the entire layer.

5. The transfer device according to claim 1,
wherein the resin contains an imide-based resin.

6. The transfer device according to claim 5,
wherein the imide-based resin contains a polyimide resin.

7. The transfer device according to claim 1,
wherein the silicone oil contains a polyether-modified alkyl silicone oil as the organic group-substituted dimethylpolysiloxane, and
the resin contains an imide-based resin.

8. The transfer device according to claim 7,
wherein the imide-based resin contains a polyimide resin.

9. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 1 that transfers the toner image to a surface of a recording medium.

10. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 2 that transfers the toner image to a surface of a recording medium.

11. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 3 that transfers the toner image to a surface of a recording medium.

12. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 4 that transfers the toner image to a surface of a recording medium.

13. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 5 that transfers the toner image to a surface of a recording medium.

14. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 6 that transfers the toner image to a surface of a recording medium.

15. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 7 that transfers the toner image to a surface of a recording medium.

16. An image forming apparatus comprising:
an image holder;
a charging device that charges a surface of the image holder;
an electrostatic latent image forming device that forms an electrostatic latent image on a surface of the charged image holder;
a developing device that contains a developer containing a toner and develops the electrostatic latent image formed on the surface of the image holder with the developer to form a toner image; and
the transfer device according to claim 8 that transfers the toner image to a surface of a recording medium.
